(19) United States
(12) Patent Application Publication
(10) Pub. No.: US 2011/0183801 A1
(43) Pub. Date: Jul. 28, 2011

(54) HYBRID DRIVE DEVICE

(75) Inventor: Masahiko ANDO, Nagoya (JP)

(73) Assignee: AISIN AW CO., LTD., Anjo-shi (JP)

(21) Appl. No.: 12/947,117

(22) Filed: Nov. 16, 2010

(30) Foreign Application Priority Data
Jan. 26, 2010 (JP) 2010-014555

(51) Int. Cl. F16H 48/06

(52) U.S. Cl. 475/5; 180/65.21; 903/902

(57) ABSTRACT

A hybrid drive device configured with an input member coupled to an engine, and an output member coupled to a wheel and a second rotary electric machine. A first and second differential gear device each have a first, second and third rotary elements arranged in the order of rotational speed. A rotation restriction device selectively stops rotation of the third rotary element. A first rotational direction restriction device only allows rotation in the positive direction. The input member is also drivably coupled to the second rotary element of the first differential gear device and the second rotary element of the second differential gear device. Furthermore, the output member is drivably coupled to the third rotary element of the second differential gear device, and the first rotary electric machine is drivably coupled to the first rotary element of the first differential gear device.

### INCORPORATION BY REFERENCE

The disclosure of Japanese Patent Application No. 2010-014555 filed on Jan. 26, 2010 including the specification, drawings and abstract is incorporated herein by reference in its entirety.

### BACKGROUND OF THE INVENTION

The present invention relates to a hybrid drive device including an input member drivably coupled to an engine, a first rotary electric machine, a second rotary electric machine, an output member drivably coupled to a wheel and the second rotary electric machine, and a first differential gear device having three rotary elements that form a sequence of a first rotary element, a second rotary element, and a third rotary element when arranged in the order of rotational speed.

### DESCRIPTION OF THE RELATED ART

A hybrid drive device including an input member drivably coupled to an engine, a first rotary electric machine, a second rotary electric machine, an output member drivably coupled to a wheel and the second rotary electric machine, and a first differential gear device having three rotary elements that form a sequence of a first rotary element, a second rotary element, and a third rotary element when arranged in the order of rotational speed is described in Japanese Patent Application Publication No. JP-A-H11-313407, for example (see FIGS. 1 and 2). In the hybrid drive device, the input member is drivably coupled to the second rotary element of the first differential gear device, the first rotary electric machine is drivably coupled to the first rotary element, and the output member is drivably coupled to the third rotary element. In addition, the output member can be selectively secured to a drive device case serving as a non-rotary member through a brake, and the second rotary electric machine drivably coupled to the wheel can be selectively drivably coupled to the output member via a clutch. The hybrid drive device is switchably operable in a plurality of modes including a series mode (S-HEV) and a split mode (P-HEV). The series mode is established by bringing the brake to an engaged state and bringing the clutch to a disengaged state, and the split mode is established by bringing the brake to a disengaged state and bringing the clutch to an engaged state.

Japanese Patent Application Publication No. JP-A-H 11-313407 also discloses a hybrid drive device further including a second differential gear device having three rotary elements that form a sequence of a first rotary element, a second rotary element, and a third rotary element when arranged in the order of rotational speed, in addition to the first differential gear device (see FIGS. 3 and 4). In the hybrid drive device, the input member is drivably coupled to the second rotary element of the first differential gear device, the first rotary electric machine is drivably coupled to the first rotary element of the first differential gear device, and the third rotary element of the first differential gear device is integrally drivably coupled to the third rotary element of the second differential gear device. In addition, the second rotary electric machine is drivably coupled to the first rotary element of the second differential gear device, and the output member drivably coupled to the wheel is drivably coupled to the second rotary element of the second differential gear device. The third rotary element of the first differential gear device and the third rotary element of the second differential gear device, which are integrally drivably coupled to each other, can be selectively secured to a drive device case serving as a non-rotary member through a brake. The hybrid drive device is also switchably operable in a plurality of modes including a series mode (S-HEV) and a split mode (P-HEV). However, the series mode is established by bringing the brake to an engaged state, and the split mode is established by bringing the brake to a disengaged state.

### SUMMARY OF THE INVENTION

In the hybrid drive device with the former configuration, however, it is necessary to simultaneously switch the states of two engagement devices, namely the brake and the clutch, in order to perform mode switching between the split mode and the series mode. Thus, attempting to perform mode switching while suppressing variations in torque to be transferred to the output member to a minimum may significantly complicate not only control of the torques and the rotational speeds of the first rotary electric machine and the second rotary electric machine and so forth, but also control of the brake and the clutch. In the hybrid drive device with the latter configuration, meanwhile, it is only necessary to switch the state of the brake in order to perform mode switching. However, since the third rotary element of the first differential gear device and the third rotary element of the second differential gear device are integrally drivably coupled to each other, it is necessary to cooperatively control the torques and the rotational speeds of the first rotary electric machine and the second rotary electric machine, which also results in significantly complicated control. That is, both of the hybrid drive devices disclosed in Japanese Patent Application Publication No. JP-A-H11-313407 require complicated control in order to perform mode switching while suppressing generation of shock to a minimum, which disadvantageously results in complicated mode switching control.

In view of the foregoing, it is desirable to provide a hybrid drive device with simple mode switching control.

The present invention provides a hybrid drive device including: an input member drivably coupled to an engine; a first rotary electric machine; a second rotary electric machine; an output member drivably coupled to a wheel and the second rotary electric machine; a first differential gear device and a second differential gear device each having three rotary elements that form a sequence of a first rotary element, a second rotary element, and a third rotary element when arranged in the order of rotational speed; a rotation restriction device that performs restriction such that rotation of the third rotary element of the first differential gear device is selectively stopped; and a first rotational direction restriction device that performs restriction such that rotation of the first rotary element of the first differential gear device relative to the first rotary element of the second differential gear device is allowed only in a positive direction. In the hybrid drive device, the input member is drivably coupled to the second rotary element of the first differential gear device and the second rotary element of the second differential gear device, the output member is drivably coupled to the third rotary element of the second differential gear device, and the first rotary electric machine is drivably coupled to the first rotary element of the first differential gear device.

The term “drivably coupled” as used herein refers to a state in which two rotary elements are coupled to each other in such a way that allows transfer of a drive force, which includes a state in which the two rotary elements are coupled to each other to rotate together, and a state in which the two rotary elements are coupled to each other via one or two or more transmission members in such a way that allows transfer of a drive force. Examples of such transmission members include various members that transfer rotation at an equal speed or a changed speed, such as a shaft, a gear mechanism, a belt, and a chain. In the case where respective rotary elements of a differential gear device are “drivably coupled” to each other, however, it is intended that the plurality of rotary elements provided in the differential gear device are drivably coupled to each other via no other rotary element.

The term “rotary electric machine” refers to any of a motor (electric motor), a generator (electric generator), and a motor generator that functions as both a motor and a generator as necessary.

The term “order of rotational speed” may refer to either of an order from the high speed side to the low speed side and an order from the low speed side to the high speed side depending on the rotating state of each differential gear mechanism. In either case, the order of the rotary elements is invariable.

The rotational direction of each rotary member is determined with reference to the rotational direction of the output member with the vehicle traveling forward. Accordingly, when a rotary member is rotating in the “positive direction”, it is intended that the rotary member is rotating in the same direction as the rotational direction of the output member with the vehicle traveling forward.

According to the above characteristic configuration, a series mode may be established with the rotation restriction device stopping rotation of the third rotary element of the first differential gear device and with the first rotary element of the first differential gear device allowed to rotate relative to the first rotary element of the second differential gear device in the positive direction. Also, a split mode may be established with the first rotational direction restriction device drivably coupling the first rotary element of the first differential gear device to the first rotary element of the second differential gear device to rotate together with the first rotary element of the second differential gear device and with the rotation restriction device allowing rotation of the third rotary element of the first differential gear device. That is, the hybrid drive device is switchably operable in a series mode which is established with the rotation restriction device stopping rotation of the third rotary element of the first differential gear device and with the first rotary element of the first differential gear device allowed to rotate relative to the first rotary element of the second differential gear device in the positive direction, and in which a torque of the input member is used by the first rotary electric machine to generate electric power, which is consumed by the second rotary electric machine to output a torque, which is transferred to the output shaft, and a split mode which is established with the first rotational direction restriction device drivably coupling the first rotary element of the first differential gear device to the first rotary element of the second differential gear device to rotate together with the first rotary element of the second differential gear device and with the rotation restriction device allowing rotation of the third rotary element of the first differential gear device, and in which the torque of the input member is transferred to the output member while being distributed to the first rotary electric machine, and the thus configured hybrid drive device may be implemented easily.

In mode switching between the series mode and the split mode, it is only necessary to control the torque and the rotational speed of the first rotary electric machine while maintaining the states of the respective rotary elements of the second differential gear device.

That is, in mode switching from the split mode to the series mode, it is only necessary to control the rotational speed of the first rotary electric machine such that the first rotary element of the first differential gear device rotates relative to the first rotary element of the second differential gear device in the positive direction, and to stop rotation of the third rotary element of the first differential gear device by restricting rotation of the third rotary element of the first differential gear device in both directions through the rotation restriction device after the rotational speed of the third rotary element of the first differential gear device becomes zero, while maintaining the states of the respective rotary elements of the second differential gear device.

In mode switching from the series mode to the split mode, meanwhile, it is only necessary to allow rotation of the third rotary element of the first differential gear device through the rotation restriction device, and to control the rotational speed of the first rotary electric machine such that rotation of the first rotary element of the first differential gear device is varied in the negative direction, while maintaining the states of the respective rotary elements of the second differential gear device. That is, when the rotational speed of the first rotary element of the first differential gear device is varied in the negative direction to become equal to the rotational speed of the first rotary element of the second differential gear device, the first rotational direction restriction device automatically drivably couples the first rotary element of the first differential gear device and first rotary element of the second differential gear device to each other to rotate together, as a result of which the split mode is established.

According to the characteristic configuration described above, mode switching between the series mode and the split mode can be performed through relatively simple control of the first rotary electric machine. It is also relatively easy to suppress variations in torque to be transferred to the output shaft in order to suppress generation of shock. Thus, the hybrid drive device with simple mode switching control can be provided.

In the above characteristic configuration, a parallel mode, in which rotation of the input member is reduced in speed and transferred to the output member and the torque of the second rotary electric machine is transferred to the output member, may be established with the rotation restriction device stopping rotation of the third rotary element of the first differential gear device and with the first rotational direction restriction device drivably coupling the first rotary element of the first differential gear device to the first rotary element of the second differential gear device to rotate together with the first rotary element of the second differential gear device. Further, a first electric power travel mode, in which the torque of the second rotary electric machine is transferred to the output member, may be established with the rotation restriction device allowing rotation of the third rotary element of the first differential gear device and with the first rotary element of the first differential gear device allowed to rotate relative to the first rotary element of the second differential gear device in the positive direction.

Accordingly, the hybrid drive device may be configured to be switchably operable in the parallel mode and the first electric power travel mode in addition to the series mode and the split mode.

Thus, preferably, the hybrid drive device is further switchably operable in a parallel mode which is established with the rotation restriction device stopping rotation of the third rotary element of the first differential gear device and with the first rotational direction restriction device drivably coupling the first rotary element of the first differential gear device to the first rotary element of the second differential gear device to rotate together with the first rotary element of the second differential gear device, and in which rotation of the input member is reduced in speed and transferred to the output member and the torque of the second rotary electric machine is transferred to the output member.

According to the configuration, the vehicle can be driven with both the amplified torque of the input member and the torque of the second rotary electric machine transferred to the output member in the parallel mode which is established with both the rotation restriction device and the first rotational direction restriction device engaged. Accordingly, the vehicle can be driven appropriately even in the case where a large drive force is required.

Preferably, the hybrid drive device is further switchably operable in a first electric power travel mode which is established with the rotation restriction device allowing rotation of the third rotary element of the first differential gear device and with the first rotary element of the first differential gear device allowed to rotate relative to the first rotary element of the second differential gear device in the positive direction, and in which the torque of the second rotary electric machine is transferred to the output member.

According to the configuration, the vehicle can be driven appropriately using the torque of the second rotary electric machine in the first electric power travel mode which is established with both the rotation restriction device and the first rotational direction restriction device disengaged. In general, it is relatively easy to precisely control the torque and the rotational speed of a rotary electric machine, and thus the vehicle can be driven appropriately in accordance with the required drive force.

Preferably, the hybrid drive device further includes a second rotational direction restriction device provided between a non-rotary member and the input member to perform restriction such that rotation of the input member relative to the non-rotary member is allowed only in the positive direction, and the hybrid drive device is further switchably operable in a second electric power travel mode which is established with the rotation restriction device allowing rotation of the third rotary element of the first differential gear device, with the first rotational direction restriction device drivably coupling the first rotary element of the first differential gear device to the first rotary element of the second differential gear device to rotate together with the first rotary element of the second differential gear device, and with the second rotational direction restriction device securing the input member to the non-rotary member, and in which a torque and a rotational direction of the first rotary electric machine are reversed and transferred to the output member and the torque of the second rotary electric machine is transferred to the output member.

According to the configuration, the respective torques of the first rotary electric machine and the second rotary electric machine can be synthesized and transferred to the output member in the second electric power travel mode which is established with the rotation restriction device disengaged and both the first rotational direction restriction device and the second rotational direction restriction device engaged. Thus, the vehicle can be driven appropriately with the engine stopped even in the case where a large drive force is required. In general, it is relatively easy to precisely control the torque and the rotational speed of a rotary electric machine, and thus the vehicle can be driven appropriately in accordance with the required drive force.

Preferably, the rotation restriction device may be provided between a non-rotary member and the third rotary element of the first differential gear device, and may be switchably operable in at least two states including a state in which restriction is performed such that rotation of the third rotary element of the first differential gear device relative to the non-rotary member is allowed only in the positive direction, and a state in which rotation of the third rotary element of the first differential gear device relative to the non-rotary member is restricted in both directions to stop rotation of the third rotary element of the first differential gear device, and mode switching from the split mode to the series mode is performed by bringing, in the split mode, the rotation restriction device to the state in which rotation of the third rotary element of the first differential gear device is allowed only in the positive direction, varying a rotational speed of the third rotary element of the first differential gear device in a negative direction, restricting the rotational speed of the third rotary element of the first differential gear device to zero through the rotation restriction device, and thereafter bringing the rotation restriction device to the state in which rotation of the third rotary element of the first differential gear device is restricted in both directions to stop rotation of the third rotary element of the first differential gear device.

According to the configuration, the split mode can be established by allowing rotation of the third rotary element of the first differential gear device in the positive direction by bringing the rotation restriction device to the state in which rotation of the third rotary element of the first differential gear device is allowed at least in the positive direction. In addition, the series mode can be established by stopping rotation of the third rotary element of the first differential gear device by bringing the rotation restriction device to the state in which rotation of the third rotary element of the first differential gear device is restricted in both directions.

According to the configuration, in addition, mode switching from the split mode to the series mode is performed by bringing the rotation restriction device to the state in which rotation of the third rotary element of the first differential gear device is allowed only in the positive direction. In this case, by continuously varying the rotational speed of the third rotary element of the first differential gear device in the negative direction, the rotational speed of the third rotary element of the first differential gear device is forcibly restricted to zero in the course of time since the rotation restriction device restricts rotation of the third rotary element of the first differential gear device in the negative direction. Accordingly, it is not necessary to converge the rotational speed of the third rotary element of the first differential gear device to zero by controlling the rotational speed of the first rotary electric machine, for example. Thus, control for mode switching from the split mode to the series mode can be further simplified.

Preferably, the rotation restriction device is a two-way clutch that is provided between a non-rotary member and the third rotary element of the first differential gear device and that is switchably operable in at least three states including a state in which rotation of the third rotary element of the first differential gear device relative to the non-rotary member is allowed in both directions, a state in which restriction is performed such that rotation of the third rotary element of the first differential gear device relative to the non-rotary member is allowed only in the positive direction, and a state in which rotation of the third rotary element of the first differential gear device relative to the non-rotary member is restricted in both directions to stop rotation of the third rotary element of the first differential gear device.

According to the configuration, the split mode can be established by allowing rotation of the third rotary element of the first differential gear device in the positive direction by bringing the two-way clutch to the state in which rotation of the third rotary element of the first differential gear device is allowed in both directions or only in the positive direction. In addition, the series mode can be established by stopping rotation of the third rotary element of the first differential gear device by bringing the two-way clutch to the state in which rotation of the third rotary element of the first differential gear device is restricted in both directions. Control for mode switching from the split mode to the series mode can be further simplified without the need to control the rotational speed of the third rotary element of the first differential gear device so as to converge to zero by bringing the two-way clutch to the state in which rotation of the third rotary element of the first differential gear device is allowed only in the positive direction in mode switching from the split mode to the series mode.

According to the configuration, the hybrid drive device according to the present invention can be formed without using a friction engagement brake or the like that operates on a hydraulic pressure or an electromagnetic force. In the case where such a configuration is adopted, it is no longer necessary to continuously generate a hydraulic pressure or an electromagnetic force in order to maintain each state that the two-way clutch may take, unlike a case where a friction engagement brake or the like is used. That is, a hydraulic pressure or an electromagnetic force is generated only when switching is performed between the respective states that the two-way clutch may take, which contributes to the improvement of the energy efficiency of the entire hybrid drive device.

Preferably, the rotation restriction device is a friction engagement brake that is provided between a non-rotary member and the third rotary element of the first differential gear device and that is switchably operable in at least two states including a state in which rotation of the third rotary element of the first differential gear device relative to the non-rotary member is allowed in both directions, and a state in which rotation of the third rotary element of the first differential gear device relative to the non-rotary member is restricted in both directions to stop rotation of the third rotary element of the first differential gear device.

According to the configuration, the production cost can be reduced by utilizing a general-purpose component such as a friction engagement brake or the like that operates on a hydraulic pressure or an electromagnetic force. In addition, mode switching from the split mode to the series mode can be performed by controlling the magnitude of the hydraulic pressure or the electromagnetic force so as to gradually increase the engagement force of the brake, which converges the rotational speed of the third rotary element of the first differential gear device to zero to secure the third rotary element of the first differential gear device.

Preferably, the hybrid drive device further includes a second rotational direction restriction device provided between a non-rotary member and the input member to perform restriction such that rotation of the input member relative to the non-rotary member is allowed only in the positive direction.

According to the configuration, a second electric power travel mode, in which a torque and a rotational direction of the first rotary electric machine are reversed and transferred to the output member and the torque of the second rotary electric machine is transferred to the output member, may be established with the rotation restriction device allowing rotation of the third rotary element of the first differential gear device, with the first rotational direction restriction device drivably coupling the first rotary element of the first differential gear device to the first rotary element of the second differential gear device to rotate together with the first rotary element of the second differential gear device, and with the second rotational direction restriction device securing the input member to the non-rotary member. Accordingly, the hybrid drive device may be configured to be further switchably operable in the second electric power travel mode in addition to the series mode, the split mode, the parallel mode, and the first electric power travel mode.

Preferably, the first differential gear device and the second differential gear device is each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

According to the configuration, when the rotational speeds of the respective ring gears of the first differential gear device and the second differential gear device are zero, the rotational speed of the sun gear of the first differential gear device is always higher than the rotational speed of the sun gear of the second differential gear device. Thus, even though the first rotational direction restriction device is provided, the sun gear of the first differential gear device rotates relative to the sun gear of the second differential gear device in the positive direction. That is, the sun gear of the first differential gear device and the sun gear of the second differential gear device are not drivably coupled to each other to rotate together. Accordingly, when the vehicle is in the stationary state with the rotational speed of the output member being zero, for example, the rotational speed of the input member can be increased using the torque of the first rotary electric machine to start up the engine with the vehicle maintained in the stationary state.

After that, the ring gear of the second differential gear device can be rotated in the negative direction until the rotational speed of the sun gear of the second differential gear device is varied in the positive direction to become equal to the rotational speed of the sun gear of the first differential gear device. Accordingly, in a range in which the rotational speed of the sun gear of the first differential gear device is higher than the rotational speed of the sun gear of the second differential gear device, for example, the vehicle can be driven in reverse in the series mode by rotating the output member and the ring gear of the second differential gear device in the negative direction using the torque of the second rotary electric machine in the negative direction. After the rotational speed of the sun gear of the second differential gear device is varied in the positive direction to become equal to the rotational speed of the sun gear of the first differential gear device, the vehicle can be driven in reverse in the parallel mode using the torque of the input member in addition.

In the case where the tooth number ratio of the second differential gear device is set to be equal to the tooth number ratio of the first differential gear device and when the vehicle is in the stationary state, the rotational speed of the input member can be increased using the torque of the first rotary electric machine to start up the engine with the vehicle maintained in the stationary state.

### BRIEF DESCRIPTION OF THE DRAWINGS

FIG. 1 is a skeleton diagram of a hybrid drive device according to a first embodiment;

FIG. 2 is a schematic diagram showing the system configuration of the hybrid drive device according to the first embodiment;

FIG. 3 is an operation table showing the state of each engagement device in each mode according to the first embodiment;

FIG. 4 is a velocity diagram for a series mode according to the first embodiment;

FIG. 5 is a velocity diagram showing the state at engine start-up according to the first embodiment;

FIG. 6 is a velocity diagram for a split mode according to the first embodiment;

FIG. 7 is a velocity diagram for a parallel mode according to the first embodiment;

FIG. 8 is a velocity diagram for an electric power travel mode according to the first embodiment;

FIG. 9 is a velocity diagram showing the process of switching between the series mode and the split mode according to the first embodiment;

FIG. 10 is a velocity diagram showing the process of switching between the series mode and the electric power travel mode according to the first embodiment;

FIG. 11 is a schematic cross-sectional view showing a specific configuration of a two-way clutch according to the first embodiment, taken in the circumferential direction;

FIG. 12 is a skeleton diagram of a hybrid drive device according to a second embodiment;

FIG. 13 is an operation table showing the state of each engagement device in each mode according to the second embodiment;

FIG. 14 is a velocity diagram for a second electric power travel mode according to the second embodiment; and

FIG. 15 is a skeleton diagram of a hybrid drive device according to another embodiment.

### DETAILED DESCRIPTION OF THE EMBODIMENTS

### 1. First Embodiment

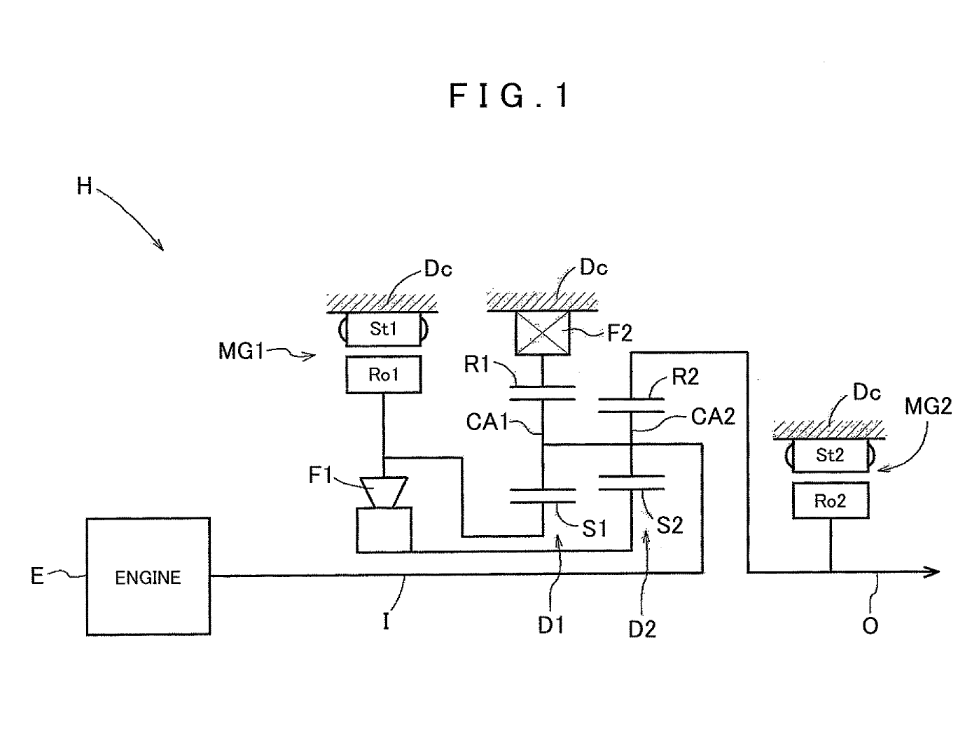

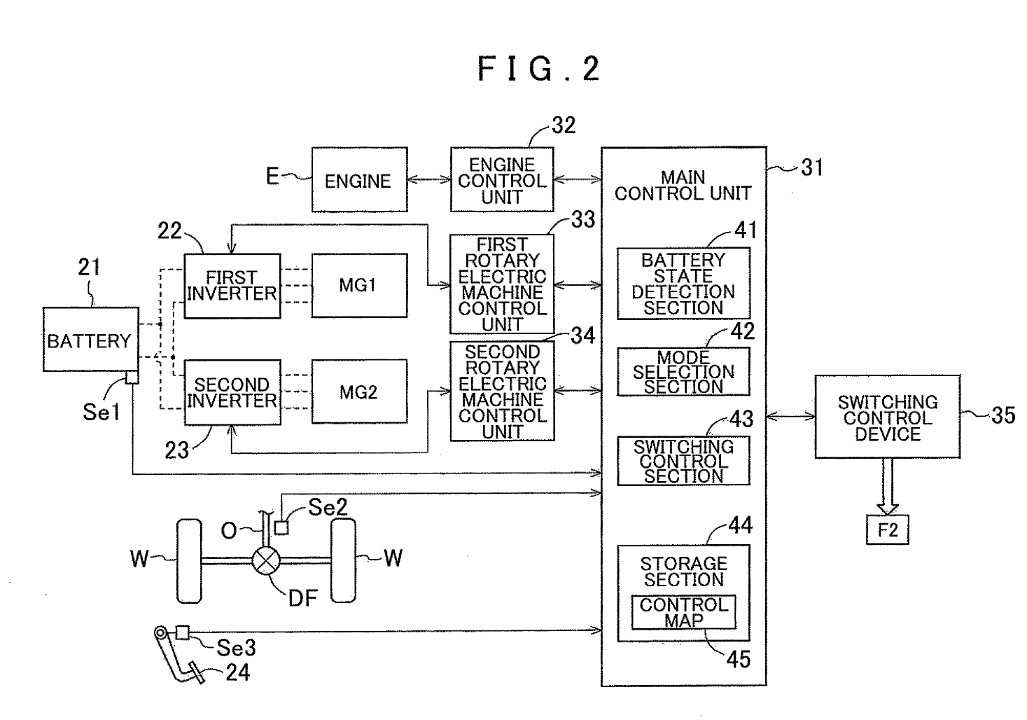

A first embodiment of the present invention will be described with reference to the drawings. FIG. 1 is a skeleton diagram showing the mechanical configuration of a hybrid drive device H according to the embodiment. In FIG. 1, the configuration of a lower half, which is symmetrical with respect to the center axis, is not shown. FIG. 2 is a schematic diagram showing the system configuration of the hybrid drive device H according to the embodiment. In FIG. 2, the solid arrows indicate transfer paths for various types of information, the broke lines indicate transfer paths for electric power, and the white arrow indicates a transfer path for motive power.

As shown in FIG. 1, the hybrid drive device H includes an input shaft I drivably coupled to an engine E, a first rotary electric machine MG1, a second rotary electric machine MG2, an output shaft O drivably coupled to wheels W (see FIG. 2) and the second rotary electric machine MG2, a first differential gear device D1, and a second differential gear device D2. These components are housed in a drive device case Dc (hereinafter simply referred to as “case Dc”) serving as a non-rotary member secured to a vehicle body. In the embodiment, the input shaft I is equivalent to the “input member” according to the present invention, and the output shaft O is equivalent to the “output member” according to the present invention.

The hybrid drive device H according to the embodiment, which is configured as described above, includes a one-way clutch F1 and a two-way clutch F2 that appropriately restrict the drivable coupling relationship of the input shaft I, the output shaft O, and the first rotary electric machine MG1 with respect to respective rotary elements of the first differential gear device D1 and the second differential gear device D2, and the rotational directions of predetermined rotary elements of the first differential gear device D1 and the second differential gear device D2. Consequently, the hybrid drive device H with simple mode switching control can be achieved. The hybrid drive device H according to the embodiment will be described in detail below.

1-1. Configuration of Various Sections of Hybrid Drive Device

As shown in FIG. 1, the input shaft I is drivably coupled to the engine E. The engine E is an internal combustion engine driven by combustion of fuel. Various engines known in the art such as a gasoline engine, a diesel engine, and a gas turbine engine may be used as the engine E. In the embodiment, the input shaft I is drivably coupled to an output rotary shaft, such as a crankshaft, of the engine E to rotate together with the output rotary shaft. It is also suitable that the input shaft I is drivably coupled to the output rotary shaft of the engine E via a damper, a clutch, or the like. The input shaft I is also drivably coupled to a first carrier CA1 of the first differential gear device D1 and a second carrier CA2 of the second differential gear device D2 to rotate together with the first carrier CA1 and the second carrier CA2. The output shaft O is drivably coupled to a second ring gear R2 of the second differential gear device D2 and a rotor Ro2 of the second rotary electric machine MG2 to rotate together with the second ring gear R2 and the rotor Ro2. As shown in FIG. 2, the output shaft O is also drivably coupled to the wheels W via an output differential gear device DF or the like so as to transfer a drive force to the wheels W. In the embodiment, the output shaft O is disposed coaxially with the input shaft I.

As shown in FIG. 1, the first rotary electric machine MG1 includes a stator St1 secured to the case Dc, and a rotor Ro1 supported on the radially inner side of the stator St1 so as to be rotatable. The rotor Ro1 of the first rotary electric machine MG1 is drivably coupled to a first sun gear S1 of the first differential gear device D1 to rotate together with the first sun gear S1, and selectively drivably coupled to a second sun gear S2 of the second differential gear device D2 via the one-way clutch F1. The second rotary electric machine MG2 includes a stator St2 secured to the case Dc, and the rotor Ro2 supported on the radially inner side of the stator St2 so as to be rotatable. The rotor Ro2 of the second rotary electric machine MG2 is drivably coupled to the second ring gear R2 of the second differential gear device D2 and the output shaft O to rotate together with the second ring gear R2 and the output shaft O. Both the first rotary electric machine MG1 and the second rotary electric machine MG2 are disposed coaxially with the input shaft I and the output shaft O. Such a configuration is suitable as a configuration of the hybrid drive device H to be mounted on FR (front-engine rear-drive) vehicles, for example. As shown in FIG. 2, the first rotary electric machine MG1 and the second rotary electric machine MG2 are electrically connected to a battery 21 serving as an electricity accumulation device via a first inverter 22 and a second inverter 23, respectively. The battery 21 is an example of the electricity accumulation device. Other types of electricity accumulation devices such as a capacitor may be used, or a plurality of types of electricity accumulation devices may be used in combination.

Each of the first rotary electric machine MG1 and the second rotary electric machine MG2 can function both as a motor (electric motor) that is supplied with electric power to generate motive power and as a generator (electric generator) that is supplied with motive power to generate electric power. When functioning as a generator, the first rotary electric machine MG1 or the second rotary electric machine MG2 uses a drive force of the engine to generate electric power for charging the battery 21 or driving the other rotary electric machine MG1 or MG2 functioning as a motor. When functioning as a motor, on the other hand, the first rotary electric machine MG1 or the second rotary electric machine MG2 is supplied with electric power charged in the battery 21 or generated by the other rotary electric machine MG1 or MG2 functioning as a generator to perform power running. Operation of the first rotary electric machine MG1 is controlled via a first rotary electric machine control unit 33 and the first inverter 22 in accordance with a control command from a main control unit 31. Operation of the second rotary electric machine MG2 is controlled via a second rotary electric machine control unit 34 and the second inverter 23 in accordance with a control command from the main control unit 31.

The first differential gear device D1 is formed by a single-pinion planetary gear mechanism disposed coaxially with the input shaft I. That is, the first differential gear device D1 includes, as its rotary elements, the first carrier CA1 that supports a plurality of pinion gears, and the first sun gear S1 and a first ring gear R1 that each mesh with the pinion gears. The first sun gear S1 is drivably coupled to the rotor Ro1 of the first rotary electric machine MG1 to rotate together with the rotor Ro1, and selectively drivably coupled to the second sun gear S2 of the second differential gear device D2 via the one-way clutch F1. The first carrier CA1 is drivably coupled to the input shaft I and the second carrier CA2 of the second differential gear device D2 to rotate together with the input shaft I and the second carrier CA2. The first ring gear R1 is selectively secured to the case Dc through the two-way clutch F2. As shown in the velocity diagrams of FIGS. 4 to 10, the three rotary elements of the first differential gear device D1 form a sequence of the first sun gear S1, the first carrier CA1, and the first ring gear R1 when arranged in the order of rotational speed. Thus, in the embodiment, the first sun gear S1, the first carrier CA1, and the first ring gear R1 are equivalent to the “first rotary element”, the “second rotary element”, and the “third rotary element”, respectively, of the first differential gear device D1.

The second differential gear device D2 is formed by a single-pinion planetary gear mechanism disposed coaxially with the input shaft I. That is, the second differential gear device D2 includes, as its rotary elements, the second carrier CA2 that supports a plurality of pinion gears, and the second sun gear S2 and the second ring gear R2 that each mesh with the pinion gears. The second sun gear S2 is selectively drivably coupled to the rotor Ro1 of the first rotary electric machine MG1 and the first sun gear S1 of the first differential gear device D1 via the one-way clutch F1. The second carrier CA2 is drivably coupled to the input shaft I and the first carrier CA1 of the first differential gear device D1 to rotate together with the input shaft I and the first carrier CM. The second ring gear R2 is drivably coupled to the output shaft O and the rotor Ro2 of the second rotary electric machine MG2 to rotate together with the output shaft O and the rotor Ro2. As shown in the velocity diagrams of FIGS. 4 to 10, the three rotary elements of the second differential gear device D2 form a sequence of the second sun gear S2, the second carrier CA2, and the second ring gear R2 when arranged in the order of rotational speed. Thus, in the embodiment, the second sun gear S2, the second carrier CA2, and the second ring gear R2 are equivalent to the “first rotary element”, the “second rotary element”, and the “third rotary element”, respectively, of the second differential gear device D2.

The one-way clutch F1 is provided between the rotor Ro1 of the first rotary electric machine MG1 and the first sun gear S1 of the first differential gear device D1 and the second sun gear S2 of the second differential gear device D2 to allow rotation of the first sun gear S1 relative to the second sun gear S2 only in the positive direction. That is, the one-way clutch F1 is provided to allow rotation of the first sun gear S1 and the rotor Ro1 of the first rotary electric machine MG1 relative to the second sun gear S2 in the positive direction, and to restrict rotation of the first sun gear S1 and the rotor Ro1 of the first rotary electric machine MG1 relative to the second sun gear S2 in the negative direction. For example, in the case where the first rotary electric machine MG1 continuously outputs a torque TM1 in the negative direction as shown in FIG. 6, the first sun gear S1 is urged to rotate relative to the second sun gear S2, which brings the one-way clutch F1 to the engaged state. The first rotary electric machine MG1 and the first sun gear S1 are thus drivably coupled to the second sun gear S2 to rotate together with the second sun gear S2. In the embodiment, the one-way clutch F1 is equivalent to the “first rotational direction restriction device” according to the present invention.

The two-way clutch F2 is provided between the case Dc serving as a non-rotary member and the first ring gear R1 of the first differential gear device D1 to selectively stop rotation of the first ring gear R1. In the embodiment, the two-way clutch F2 is switchably operable in three states, namely a disengaged state, a one-direction engaged state, and an engaged state (hereinafter occasionally specifically referred to as “two-direction engaged state” for differentiation from the one-direction engaged state). In the disengaged state, rotation of the first ring gear R1 relative to the case Dc is allowed in both directions (the positive direction and the negative direction). In the one-direction engaged state, in the embodiment, restriction is performed such that rotation of the first ring gear R1 relative to the case Dc is allowed only in the positive direction. In the one-direction engaged state, the two-way clutch F2 allows rotation of the first ring gear R1 relative to the case Dc in the positive direction, and restricts rotation of the first ring gear R1 relative to the case Dc in the negative direction. For example, in the case where the rotational speed of the first ring gear R1 is continuously varied in the negative direction while the first ring gear R1 is rotating in the positive direction, the two-way clutch F2 is brought to the engaged state when the rotational speed of the first ring gear R1 becomes zero so that the first ring gear R1 is secured to the case Dc. In the two-direction engaged state, rotation of the first ring gear R1 relative to the case Dc is restricted in both directions (the positive direction and the negative direction) to stop rotation of the first ring gear R1. In the embodiment, the two-way clutch F2 is equivalent to the “rotation restriction device” according to the present invention.

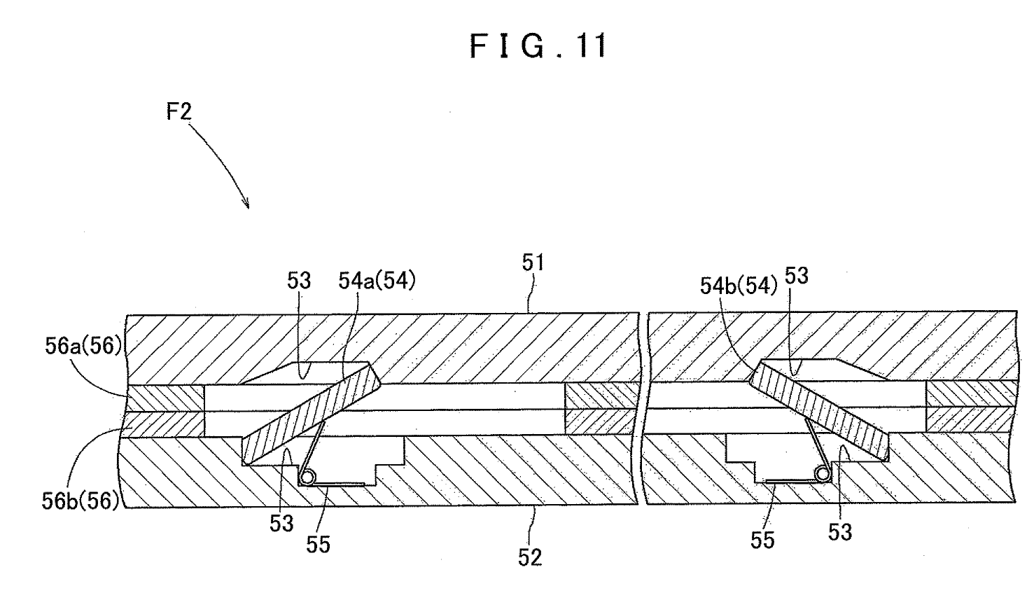

In the embodiment, as shown in FIG. 11, the two-way clutch F2 includes a generally disc-like first rotary member 51 and a generally disc-like second rotary member 52 that are disposed opposite each other so as to be rotatable relative to each other, a plurality of engagement members 54 disposed so as to be engageable with both the first rotary member 51 and the second rotary member 52 in a state of being urged by an elastic member 55 such as a spring, and blocking members 56 capable of blocking engagement of the engagement members 54 with both the first rotary member 51 and the second rotary member 52 against the urging force of the elastic member 55. The first rotary member 51 and the second rotary member 52 have respective recesses 53 disposed opposite each other. The engagement member 54 and the elastic member 55 are housed in the recesses 53. The engagement member 54 is engaged with both the first rotary member 51 and the second rotary member 52 in the recesses 53 in a state of being urged from the second rotary member 52 side to the first rotary member 51 side by the elastic member 55. In this state, relative rotation between the first rotary member 51 and the second rotary member 52 in the direction in which the engagement member 54 becomes lodged in the recess 53 is restricted. The two-way clutch F2 according to the embodiment includes, as the engagement members 54, a first engagement member 54a and a second engagement member 54b that become lodged in the recesses 53 in opposite directions to each other. The two-way clutch F2 also includes a first blocking member 56a capable of blocking engagement of the first engagement member 54a with both the first rotary member 51 and the second rotary member 52, and a second blocking member 56b capable of blocking engagement of the second engagement member 54b with both the first rotary member 51 and the second rotary member 52.

When both the first engagement member 54a and the second engagement member 54b are engaged with both the first rotary member 51 and the second rotary member 52, relative rotation between the first rotary member 51 and the second rotary member 52 is restricted in both directions to stop rotation of the first rotary member 51 and the second rotary member 52. This state is the “two-direction engaged state” discussed above. When the first blocking member 56a blocks engagement of the first engagement member 54a with both the first rotary member 51 and the second rotary member 52, the second engagement member 54b allows relative rotation between the first rotary member 51 and the second rotary member 52 only in one direction (in the example of FIG. 11, the direction in which the first rotary member 51 rotates leftward relative to the second rotary member 52). When the second blocking member 56b blocks engagement of the second engagement member 54b with both the first rotary member 51 and the second rotary member 52, the first engagement member 54a allows relative rotation between the first rotary member 51 and the second rotary member 52 only in the other direction (in the example of FIG. 11, the direction in which the first rotary member 51 rotates rightward relative to the second rotary member 52). Either of these states is the “one-direction engaged state” discussed above. When engagement of both the first engagement member 54a and the second engagement member 54b with both the first rotary member 51 and the second rotary member 52 is blocked, relative rotation between the first rotary member 51 and the second rotary member 52 is allowed in both directions. This state is the “disengaged state” discussed above.

In the embodiment, a switching control device 35 (see FIG. 2) is provided to switch the state of the two-way clutch F2, in other words, to switch whether or not the first blocking member 56a and the second blocking member 56b block engagement of the first engagement member 54a and the second engagement member 54b, respectively. In the embodiment, an electric actuator such as a linear motor is used as the switching control device 35. Alternatively, a hydraulic actuator that utilizes a hydraulic pressure generated by an electric oil pump or the like may be used to form the switching control device 35. With the two-way clutch F2 configured as described above, it is only necessary to actuate the switching control device 35 when switching is performed between the respective states that the two-way clutch F2 may take. Thus, it is no longer necessary to continuously generate an electromagnetic force in order to maintain the engaged state or the disengaged state, unlike a case where a friction engagement brake or the like is used, for example. Accordingly, the energy efficiency of the entire hybrid drive device H can be improved by using the two-way clutch F2 as the rotation restriction device.

1-2. Configuration of Control System of Hybrid Drive Device

As shown in FIG. 2, the hybrid drive device H includes the main control unit 31 that controls various sections of the device. The main control unit 31 is connected to an engine control unit 32, the first rotary electric machine control unit 33, the second rotary electric machine control unit 34, and the switching control device 35 to allow transfer of information between each other. The engine control unit 32 controls various sections of the engine E such that the engine E achieves desired rotational speed and torque. The first rotary electric machine control unit 33 controls the first inverter 22 such that the first rotary electric machine MG1 achieves desired rotational speed and torque. The second rotary electric machine control unit 34 controls the second inverter 23 such that the second rotary electric machine MG2 achieves desired rotational speed and torque.

In addition, the main control unit 31 is configured to acquire information from sensors or the like provided at various sections of the vehicle incorporating the hybrid drive device H in order to acquire information on the various sections of the vehicle. In the illustrated example, the main control unit 31 is configured to acquire information from a battery state detection sensor Se1, a vehicle speed sensor Se2, and an accelerator pedal operation detection sensor Se3. The battery state detection sensor Se1 is a sensor that detects the state of the battery 21 such as a charge amount, and may be formed by a voltage sensor, a current sensor, or the like, for example. The vehicle speed sensor Se2 is a sensor that detects the rotational speed of the output shaft O in order to detect the vehicle speed. The accelerator pedal operation detection sensor Se3 is a sensor that detects the operation amount of an accelerator pedal 24.

The main control unit 31 uses the information acquired from the sensors Se1 to Se3 to select among a plurality of operation modes to be discussed later. The main control unit 31 switches among the operation modes by switching the state of the two-way clutch F2 via the switching control device 35 and controlling the rotational speed and the torque of the first rotary electric machine MG1 via the first rotary electric machine control unit 33 and the first inverter 22. In addition, the main control unit 31 cooperatively controls the operating states of the engine E, the first rotary electric machine MG1, and the second rotary electric machine MG2 via the engine control unit 32, the first rotary electric machine control unit 33, and the second rotary electric machine control unit 34 such that the vehicle is driven appropriately in accordance with the selected operation mode.

In the embodiment, the main control unit 31 includes a battery state detection section 41, a mode selection section 42, and a switching control section 43 as functional sections that execute various types of control. Each functional section (unit) provided in the main control unit 31 includes an arithmetic processing unit such as a CPU serving as its core member, and a functional unit implemented by hardware, software (a program), or a combination of both to perform various processes on input data. The main control unit 31 also includes a storage section 44 storing a control map 45 for use to determine the operation mode in accordance with the vehicle speed and the required drive force.

The battery state detection section 41 detects, through estimation, the state of the battery 21 such as a charge amount on the basis of information output from the battery state detection sensor Se1 such as a voltage value or a current value. The battery charge amount is generally called SOC (state of charge), and may be obtained as the ratio of the remaining charge amount to the charge capacity of the battery 21, for example.

The mode selection section 42 selects an appropriate operation mode in accordance with the states of various sections of the vehicle using a predetermined control map. In the embodiment, the mode selection section 42 selects an appropriate operation mode from four operation modes to be discussed later in accordance with the travel conditions such as the vehicle speed, the required drive force, and the battery charge amount. Each of the operation modes will be described in detail later. The required drive force is a value representing the drive force required from the vehicle by a driver. The required drive force is acquired, through computation, by the mode selection section 42 on the basis of the output of the accelerator pedal operation detection sensor Se3. The vehicle speed is detected by the vehicle speed sensor Set. The battery charge amount is detected by the battery state detection section 41. It is also suitable to use various conditions such as the coolant temperature and the oil temperature, in addition to the vehicle speed, the required drive force, and the battery charge amount, as travel conditions to be referenced for mode selection.

The switching control section 43 switches the two-way clutch F2 among the disengaged state, the one-direction engaged state, and the two-direction engaged state by controlling operation of the switching control device 35 in accordance with the operation mode selected by the mode selection section 42. Consequently, the switching control section 43 performs part of control for switching the operation mode of the hybrid drive device H.

1-3. Plurality of Switchable Modes

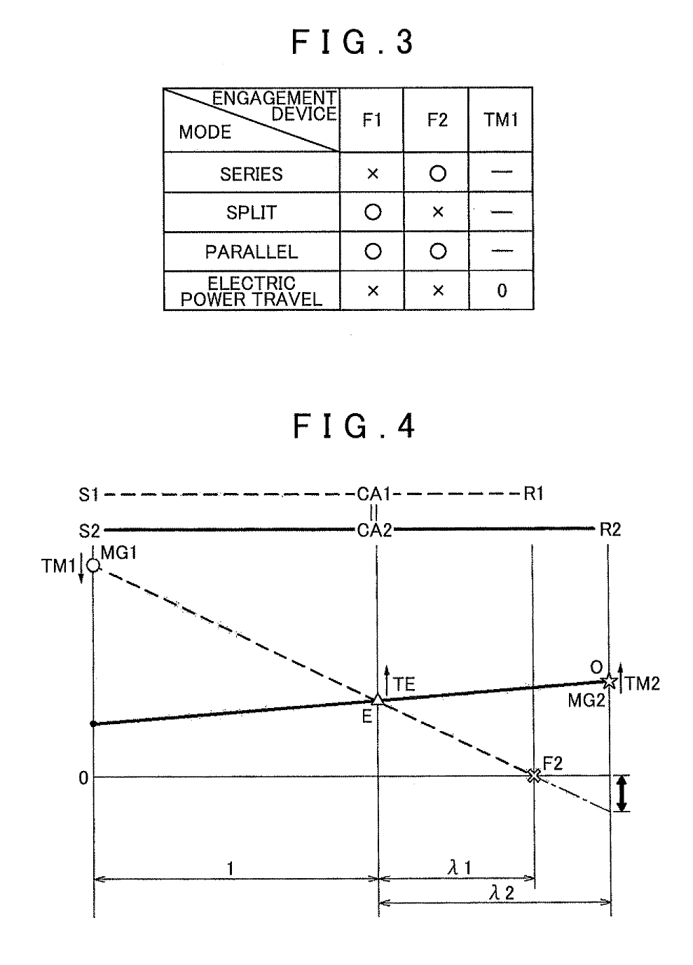

Next, the modes that can be established by the hybrid drive device H according to the embodiment will be described below. FIG. 3 is an operation table showing the operating states of the respective engagement devices F1 and F2 and the direction of the torque TM1 of the first rotary electric machine MG1 in each mode. In FIG. 3, the symbol “∘” indicates that each engagement device is in the engaged state (for the two-way clutch F2, in the two-direction engaged state), and the symbol “x” indicates that each engagement device is in the disengaged state. In FIG. 3, in addition, the symbol “-” indicates that the torque TM1 of the first rotary electric machine MG1 is in the negative direction, and the symbol “0” indicates that the first rotary electric machine MG1 is basically outputting no torque TM1, and making no rotation or idling. In the embodiment, as shown in FIG. 3, the hybrid drive device H is switchably operable in four modes, namely a “series mode”, a “split mode”, a “parallel mode”, and an “electric power travel mode”.

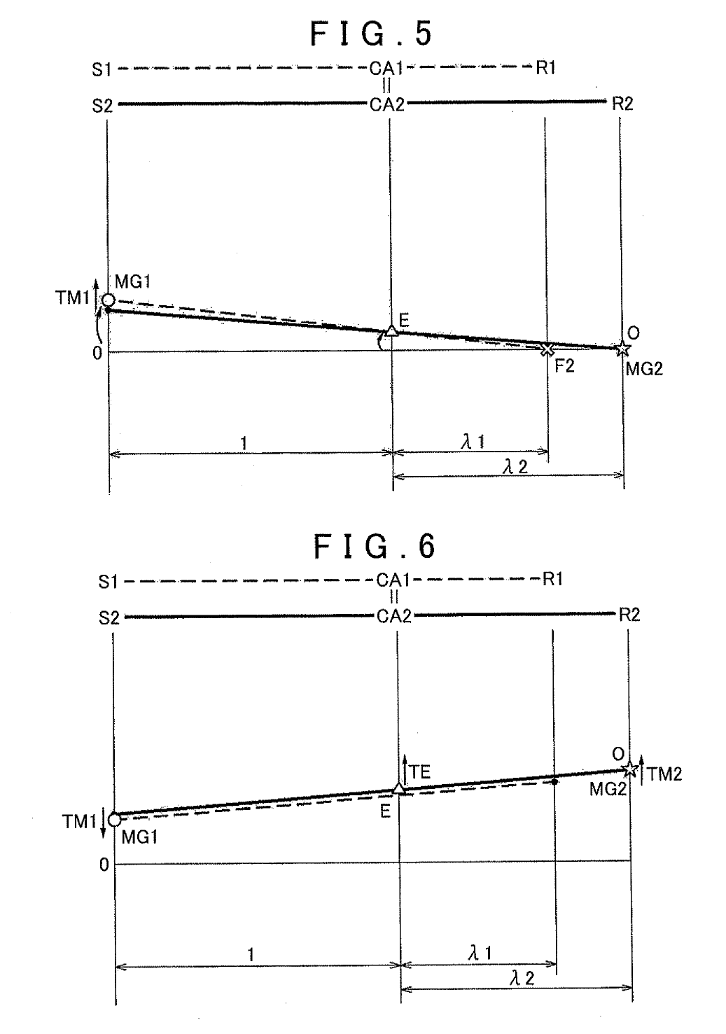

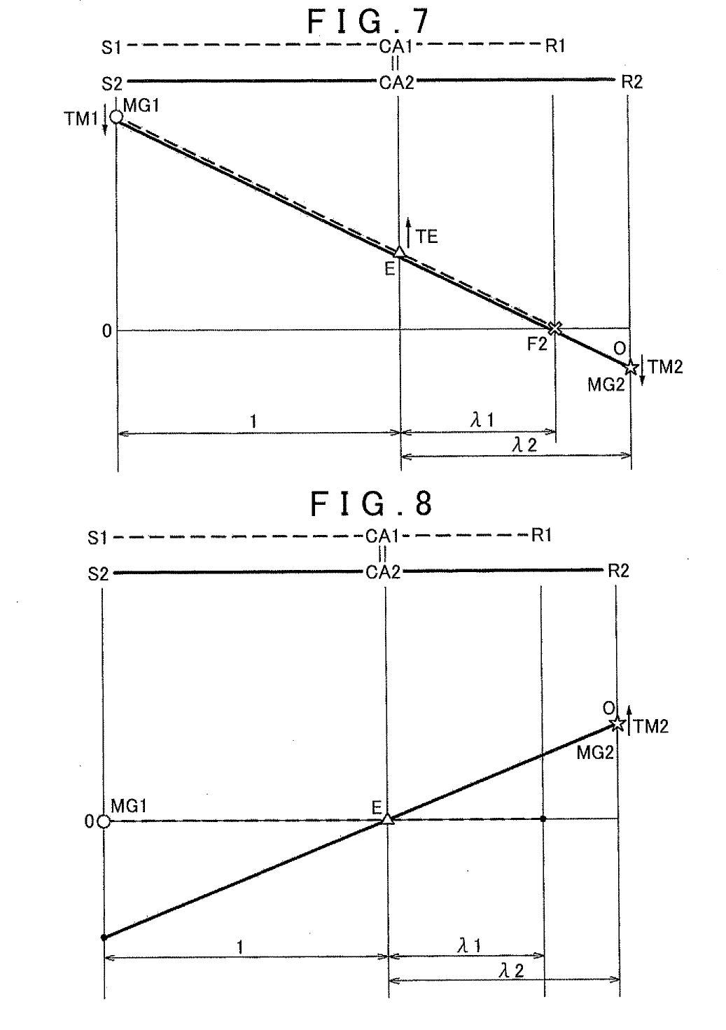

FIGS. 4 to 8 are each a velocity diagram of the first differential gear device D1 and the second differential gear device D2 provided in the hybrid drive device H. FIGS. 4 and 5 are each a velocity diagram for the series mode. FIG. 6 is a velocity diagram for the split mode. FIG. 7 is a velocity diagram for the parallel mode. FIG. 8 is a velocity diagram for the electric power travel mode. In the velocity diagrams, the vertical axis corresponds to the rotational speed of each rotary element. That is, the point “0” on the vertical axis indicates that the rotational speed is zero, with the upper side being the positive side and the lower side being the negative side. A plurality of vertical lines disposed in parallel correspond to the respective rotary elements of the differential gear devices D1 and D2. In the velocity diagrams shown in FIGS. 4 to 8, in addition, the broken straight line indicates the operating state of the first differential gear device D1, and the solid straight line indicates the operating state of the second differential gear device D2. In the velocity diagrams, the symbol “∘” indicates the rotational speed of the first rotary electric machine MG1, the symbol “Δ” indicates the rotational speed of the input shaft I (engine E), the symbol “★” indicates the rotational speed of the output shaft O and the second rotary electric machine MG2, and the symbol “x” indicates the state of being secured to the case Dc through the two-way clutch F2.

The intervals between the vertical lines corresponding to the respective rotary elements correspond to the tooth number ratio λ1 of the planetary gear mechanism forming the first differential gear device D1 and the tooth number ratio λ2 of the planetary gear mechanism forming the second differential gear device D2. The tooth number ratios λ1 and λ2 are shown in the lower portion of FIGS. 4 to 8. The tooth number ratio of each planetary gear mechanism is the ratio of the number of teeth of the sun gear forming the planetary gear mechanism to the number of teeth of the ring gear forming the planetary gear mechanism (=[number of teeth of sun gear]/[number of teeth of ring gear]). In the embodiment, as is clear from FIGS. 4 to 8, the tooth number ratio λ2 of the second differential gear device D2 is set to be larger than the tooth number ratio λ1 of the first differential gear device D1 (λ2>λ1). The specific values of the tooth number ratios λ1 and λ2 may be set appropriately in consideration of the characteristics of the engine E and the first rotary electric machine MG1 and the second rotary electric machine MG2, the vehicle weight, and so forth. The operating state of the hybrid drive device H in each operation mode will be described in detail below.

1-3-1. Series Mode

In the series mode, a torque TE of the input shaft I (engine E) is used by the first rotary electric machine MG1 to generate electric power, which is consumed by the second rotary electric machine MG2 to output a torque TM2, which is transferred to the output shaft O. As shown in FIG. 3, the series mode is established with the one-way clutch F1 in the disengaged state and the two-way clutch F2 in the two-direction engaged state. That is, the series mode is established with rotation of the first ring gear R1 of the first differential gear device D1 stopped with the two-way clutch F2 in the two-direction engaged state, and with the first sun gear S1 of the first differential gear device D1 allowed to rotate relative to the second sun gear S2 of the second differential gear device D2 in the positive direction with the one-way clutch F1 in the disengaged state.

In the series mode, as shown in the velocity diagram of FIG. 4, the line representing the first differential gear device D1 and the line representing the second differential gear device D2 are different lines. In the first differential gear device D1, the first ring gear R1, which is on one side in the order of rotational speed, is secured to the case Dc through the two-way clutch F2, and the input shaft I, which rotates together with the second carrier CA2 of the second differential gear device D2, is drivably coupled to the first carrier CA1, which is at the middle in the order of rotational speed. In addition, the rotor Ro1 of the first rotary electric machine MG1 is drivably coupled to the first sun gear S1, which is on the other side in the order of rotational speed. In this state, the first rotary electric machine MG1, which rotates in the positive direction using the torque TE of the input shaft I (engine E) in the positive direction, outputs the TM1 in the negative direction as also shown in FIG. 3. Consequently, the first rotary electric machine MG1 generates electric power by outputting the torque TM1 in the negative direction while rotating in the positive direction.

In the second differential gear device D2, the output shaft O and the rotor Rot of the second rotary electric machine MG2 are drivably coupled to the second ring gear R2, which is on one side in the order of rotational speed, and the input shaft I, which rotates together with the first carrier CA1 of the first differential gear device D1, is drivably coupled to the second carrier CA2, which is at the middle in the order of rotational speed. In the embodiment, the first carrier CA1 and the second carrier CA2 are drivably coupled to each other to rotate together with each other, and the tooth number ratio λ2 of the second differential gear device D2 is set to be larger than the tooth number ratio λ1 of the first differential gear device D1. Therefore, when the vehicle is traveling forward, when the rotational speed of the output shaft O, which rotates together with the second ring gear R2, is positive (including a case where the vehicle is stationary, when the rotational speed of the output shaft O is zero), the rotational speed of the second sun gear S2, which is on the other side in the order of rotational speed, is always lower than the rotational speed of the first sun gear S1. Accordingly, when the vehicle is traveling forward in the series mode, the first sun gear S1 always rotates relative to the second sun gear S2 in the positive direction to bring the one-way clutch F1 to the disengaged state, which interrupts torque transfer between the input shaft I (engine E) and the output shaft O. In this state, the torque TM2 in the positive direction output from the second rotary electric machine MG2 is transferred to the output shaft O. The vehicle thus travels. In this event, the second rotary electric machine MG2 consumes electric power generated by the first rotary electric machine MG1 to output the torque TM2 in the positive direction. When the vehicle is decelerating, the second rotary electric machine MG2 generates electric power by outputting the torque TM2 in the negative direction while rotating in the positive direction to perform regenerative braking.

In the embodiment, even when the vehicle is traveling in reverse, when the rotational speed of the output shaft O, which rotates together with the second ring gear R2, is negative, the rotational speed of the second sun gear S2, which is on the other side in the order of rotational speed, is lower than the rotational speed of the first sun gear S1 when the vehicle is traveling in reverse at a very slow speed with the rotational speed of the output shaft O being a predetermined value or less. Accordingly, the first sun gear S1 rotates relative to the second sun gear 52 in the positive direction to bring the one-way clutch F1 to the disengaged state in the same way as described above, which enables reverse travel in the series mode. In FIG. 4, a range of the rotational speed of the output shaft O that enables such reverse travel in the series mode is indicated by the thick arrow.

In the embodiment, the series mode can also be utilized as an engine start-up mode in which the engine E is started up using the torque TM1 of the first rotary electric machine MG1 while the vehicle is stationary. FIG. 5 shows a velocity diagram at the time of starting up the engine E. In the series mode (engine start-up mode), as described above, in the first differential gear device D1, the first ring gear R1, which is on one side in the order of rotational speed, is secured to the case Dc through the two-way clutch F2, and the first rotary electric machine MG1 is drivably coupled to the first sun gear S1, which is on the other side in the order of rotational speed. In addition, the input shaft I is drivably coupled to the first carrier CA1, which is at the middle in the order of rotational speed. Accordingly, as a result of the first rotary electric machine MG1 outputting the torque TM1 in the positive direction to vary its rotational speed in the positive direction, the rotational speed of the engine E, which is drivably coupled to the first carrier CA1 and the input shaft I to rotate together with the first carrier CA1 and the input shaft I, can be increased to start up the engine E. At this time, since the tooth number ratio λ2 of the second differential gear device D2 is larger than the tooth number ratio λ1 of the first differential gear device D1, the rotational speed of the second sun gear S2 is always lower than the rotational speed of the first sun gear S1 to keep the one-way clutch F1 in the disengaged state, even while the vehicle is stationary with the rotational speed of the second ring gear R2, which rotates together with the output shaft O, being zero. That is, the rotational speed of the second sun gear S2 does not become higher than the rotational speed of the first sun gear S1 to engage the one-way clutch F1 so that the second sun gear S2 and the first sun gear S1 are drivably coupled to each other to rotate together with each other. Accordingly, when the vehicle is in the stationary state, the engine E can be started up with the vehicle maintained in the stationary state.

1-3-2. Split Mode

In the split mode, the torque TE of the input shaft I (engine E) is transferred to the output shaft O while being distributed to the first rotary electric machine MG1. As shown in FIG. 3, the split mode is established with the one-way clutch F1 in the engaged state and the two-way clutch F2 in the disengaged state. That is, the split mode is established with the first sun gear S1 of the first differential gear device D1 urged to rotate relative to the second sun gear S2 of the second differential gear device D2 in the negative direction to engage the one-way clutch F1, which drivably couples the first sun gear S1 and the second sun gear S2 to each other to rotate together, and with the first ring gear R1 of the first differential gear device D1 allowed to rotate with the two-way clutch F2 in the disengaged state.

In the split mode, as shown in the velocity diagram of FIG. 6, the line representing the first differential gear device D1 and the line representing the second differential gear device D2 are identical lines. In the second differential gear device D2, the input shaft I, which rotates together with the first carrier CA1 of the first differential gear device D1, is drivably coupled to the second carrier CA2, which is at the middle in the order of rotational speed, and the output shaft O and the rotor Ro2 of the second rotary electric machine MG2 are drivably coupled to the second ring gear R2, which is on one side in the order of rotational speed. In the first differential gear device D1, the input shaft I, which rotates together with the second carrier CA2 of the second differential gear device D2, is drivably coupled to the first carrier CA1, which is at the middle in the order of rotational speed, and the rotor Ro1 of the first rotary electric machine MG1 is drivably coupled to the first sun gear S1, which is on one side in the order of rotational speed. In this state, the first rotary electric machine MG1 outputs the torque TM1 in the negative direction as also shown in FIG. 3. As a result of the first rotary electric machine MG1 outputting the torque TM1 in the negative direction, the rotational speed of the first sun gear S1 is reduced, and the first sun gear S1 is urged to rotate relative to the second sun gear S2 in the negative direction. When the rotational speed of the first sun gear S1 relative to the second sun gear S2 becomes zero, the one-way clutch F1 is brought to the engaged state, which drivably couples the first rotary electric machine MG1 and the first sun gear S1 to the second sun gear S2 to rotate together with the second sun gear S2.

In the split mode, the torque TE of the input shaft I (engine E) is transferred to the second carrier CA2, which is drivably coupled to the input shaft I to rotate together with the input shaft I. In this event, the engine E outputs the torque TE in the positive direction matching the required drive force while being controlled so as to be maintained in a state with high efficiency and low gas emission (a state according to optimum fuel consumption characteristics), and the torque TE is transferred to the second carrier CA2 via the input shaft I. The torque TE of the input shaft I (engine E) transferred to the second carrier CA2 is attenuated by the second differential gear device D2, and transferred to the output shaft O. That is, in the second differential gear device D2, the torque TE of the input shaft I (engine E) is input to the second carrier CA2, which is at the middle in the order of rotational speed, and the torque TM1 of the first rotary electric machine MG1 is input to the second sun gear S2, which is on one side in the order of rotational speed, via the first sun gear S1 and the one-way clutch F1. In addition, the output shaft O is drivably coupled to the second ring gear R2, which is on the other side in the order of rotational speed. In this event, the first rotary electric machine MG1 outputs the torque TM1 in the negative direction as described above, and functions to receive a reaction force of the torque TE of the input shaft I (engine E). Consequently, the second differential gear device D2 distributes part of the torque TE of the input shaft I (engine E) distributed to the second carrier CA2 to the first rotary electric machine MG1, and transfers a torque attenuated relative to the torque TE of the input shaft I (engine E) to the output shaft O. The vehicle thus travels.

At this time, the first rotary electric machine MG1 generates electric power by basically outputting the torque TM1 in the negative direction while rotating in the positive direction. Meanwhile, the second rotary electric machine MG2 consumes electric power generated by the first rotary electric machine MG1 to perform power running, and outputs the torque TM2 in the positive direction to supplement the torque to be transferred to the output shaft O. When the vehicle is decelerating, the second rotary electric machine MG2 generates electric power by outputting the torque TM2 in the negative direction while rotating in the positive direction to perform regenerative braking. Thus, in the split mode, electric power of the battery 21 is not basically consumed. When the vehicle speed (the rotational speed of the output shaft O) becomes higher and the rotational speed of the second ring gear R2 becomes higher than a predetermined value, on the other hand, the first rotary electric machine MG1 generates the torque TM1 in the negative direction while rotating in the negative direction to perform power running. In this case, in order to generate electric power for power running of the first rotary electric machine MG1, the second rotary electric machine MG2 generates electric power by outputting the torque TM2 in the negative direction while rotating in the positive direction.

1-3-3. Parallel Mode

In the parallel mode, the torque TE of the input shaft I (engine E) and the torque TM2 of the second rotary electric machine MG2 are transferred to the output shaft O. In the embodiment, in the parallel mode, the torque TE is amplified, with the rotational speed of the input shaft I (engine E) reduced, and transferred to the output shaft O, and the torque TM2 of the second rotary electric machine MG2 is transferred as it is to the output shaft O. As shown in FIG. 3, the parallel mode is established with both the one-way clutch F1 and the two-way clutch F2 in the engaged state (for the two-way clutch F2, in the two-direction engaged state). That is, the parallel mode is established with rotation of the first ring gear R1 of the first differential gear device D1 stopped with the two-way clutch F2 in the two-direction engaged state, and with the first sun gear S1 of the first differential gear device D1 urged to rotate relative to the second sun gear S2 of the second differential gear device D2 in the negative direction to engage the one-way clutch F1, which drivably couples the first sun gear S1 to the second sun gear S2 to rotate together with the second sun gear S2. In the embodiment, the parallel mode is established only when the vehicle is traveling in reverse, that is, when the rotational speed of the output shaft O, which rotates together with the second ring gear R2, is negative.

In the parallel mode, as shown in the velocity diagram of FIG. 7, the line representing the first differential gear device D1 and the line representing the second differential gear device D2 are identical lines. In the first differential gear device D1, the first ring gear R1, which is on one side in the order of rotational speed, is secured to the case Dc through the two-way clutch F2, and the input shaft I, which rotates together with the second carrier CA2 of the second differential gear device D2, is drivably coupled to the first carrier CA1, which is at the middle in the order of rotational speed. In addition, the rotor Ro1 of the first rotary electric machine MG1 is drivably coupled to the first sun gear S1, which is on the other side in the order of rotational speed. In this state, the first rotary electric machine MG1 outputs the torque TM1 in the negative direction as also shown in FIG. 3. In the second differential gear device D2, meanwhile, the output shaft O and the rotor Ro2 of the second rotary electric machine MG2 are drivably coupled to the second ring gear R2, which is on one side in the order of rotational speed, and the input shaft I, which rotates together with the first carrier CA1 of the first differential gear device D1, is drivably coupled to the second carrier CA2, which is at the middle in the order of rotational speed. In this state, the second rotary electric machine MG2 outputs the torque TM2 in the negative direction. As a result of the first rotary electric machine MG1 outputting the torque TM1 in the negative direction, the rotational speed of the first sun gear S1 is reduced. As a result of the second rotary electric machine MG2 outputting the torque TM2 in the negative direction, the rotational speed of the second sun gear S2 is increased. The first sun gear S1 is thus urged to rotate relative to the second sun gear S2 in the negative direction. When the rotational speed of the first sun gear S1 relative to the second sun gear S2 becomes zero, the one-way clutch F1 is brought to the engaged state, which drivably couples the first rotary electric machine MG1 and the first sun gear S1 to the second sun gear S2 to rotate together with the second sun gear S2.

Consequently, two (the first carrier CA1 and the first sun gear S1) of the three rotary elements of the first differential gear device D1 and two (the second carrier CA2 and the second sun gear S2) of the three rotary elements of the second differential gear device D2 are respectively drivably coupled to each other to establish a four-element state. In the four-element state, as shown in FIG. 7, the four rotary elements form a sequence of the first sun gear S1 and the second sun gear S2 which rotate together, the first carrier CA1 and the second carrier CA2 which rotate together, the first ring gear R1, and the second ring gear R2 when arranged in the order of rotational speed.

In the parallel mode, the rotational speed of the input shaft I (engine E) is changed on the basis of the rotating states of three of the four rotary elements, namely the first carrier CA1 and the second carrier CA2 which rotate together, the first ring gear R1, and the second ring gear R2, and transferred to the output shaft O. That is, the first ring gear R1, which is at the middle in the order of rotational speed, of the three rotary elements, is secured to the case Dc through the two-way clutch F2, and the input shaft I is drivably coupled to the first carrier CA1 and the second carrier CA2, which are on one side in the order of rotational speed. In addition, the output shaft O and the rotor Rot of the second rotary electric machine MG2 are drivably coupled to the second ring gear R2, which is on the other side in the order of rotational speed. Consequently, rotation in the positive direction and the torque TE of the input shaft I (engine E) transferred to the first carrier CA1 and the second carrier CA2 are reversed and transferred to the output shaft O. Meanwhile, the second rotary electric machine MG2 outputs the torque TM2 in the negative direction to supplement the torque to be transferred to the output shaft O. The vehicle thus travels in reverse. In this event, with λ1 and λ2 set in the embodiment, the rotational speed of the input shaft I (engine E) is reduced and the torque TE is amplified, before being transferred to the output shaft O.

1-3-4. Electric Power Travel Mode

In the electric power travel mode, the torque TM2 of the second rotary electric machine MG2 is transferred to the output shaft O. As shown in FIG. 3, the electric power travel mode is established with both the one-way clutch F1 and the two-way clutch F2 in the disengaged state. That is, the electric power travel mode is established with the first ring gear R1 of the first differential gear device D1 allowed to rotate with the two-way clutch F2 in the disengaged state, and with the first sun gear S1 of the first differential gear device D1 allowed to rotate relative to the second sun gear S2 of the second differential gear device D2 in the positive direction with the one-way clutch F1 in the disengaged state.

When the vehicle is traveling forward in the electric power travel mode, as shown in the velocity diagram of FIG. 8, the line representing the first differential gear device D1 and the line representing the second differential gear device D2 are different lines. In the electric power travel mode, however, substantially no torque is transferred by the first differential gear device D1 or the second differential gear device D2. That is, in the electric power travel mode, no torque is transferred via the first differential gear device D1 or the second differential gear device D2, and only the torque TM2 of the second rotary electric machine MG2, which is drivably coupled to the output shaft O to rotate together with the output shaft O, is transferred to the output shaft O. The vehicle thus travels. In the electric power travel mode, the first rotary electric machine MG1 is stopped, and the rotational speed of the first sun gear S1, which is drivably coupled to the first rotary electric machine MG1, is generally zero. The engine is also stopped, and the respective rotational speeds of the input shaft I and the first carrier CA1 and the second carrier CA2, which are drivably coupled to the input shaft I, are kept generally zero. Therefore, when the vehicle is traveling forward, when the rotational speed of the output shaft O, which rotates together with the second ring gear R2, is positive, the second sun gear S2 rotates in the negative direction to make the rotational speed of the second sun gear S2 lower than the rotational speed of the first sun gear S1, which allows the first sun gear S1 to rotate relative to the second sun gear S2 in the positive direction to bring the one-way clutch F1 to the disengaged state.

1-4. Switching Between Modes

Next, switching between modes will be described. In the embodiment, as described above, any of the series mode, the split mode, and the electric power travel mode is selected when the vehicle is traveling forward. For example, the electric power travel mode may be selected when the vehicle is starting to move, the series mode may be selected when the charge amount of the battery 21 is reduced to a predetermined value or less while the vehicle is traveling in the electric power travel mode, and the split mode may be selected in the case where the required drive force is not achieved with only the torque TM2 of the second rotary electric machine MG2 while the vehicle is traveling in the series mode. Thus, mode switching between the series mode and the split mode and mode switching between the electric power travel mode and the series mode will be specifically described below. The above conditions for mode selection are merely examples, and mode selection may be performed on the basis of various other conditions.

1-4-1. Switching Between Series Mode and Split Mode

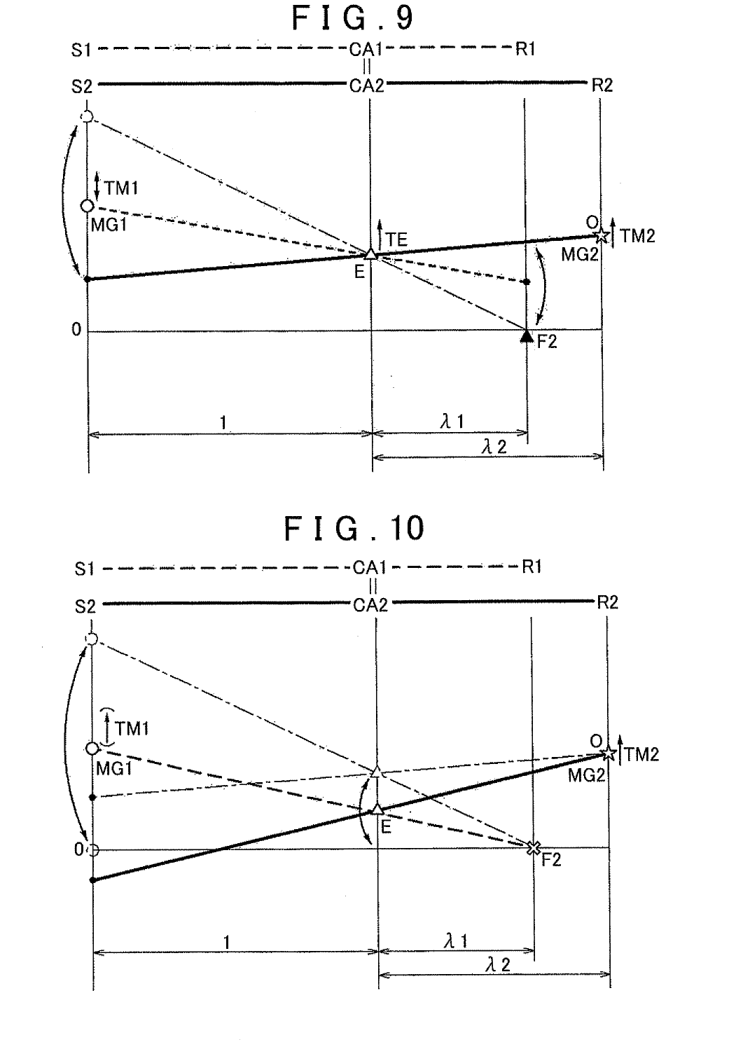

FIG. 9 is a velocity diagram showing the process of switching between the series mode and the split mode. When mode switching from the split mode to the series mode is performed, the one-way clutch F1 is disengaged into the disengaged state, and the two-way clutch F2 is engaged into the two-direction engaged state. In the split mode, as described above, the first sun gear S1 of the first differential gear device D1 is urged to rotate relative to the second sun gear S2 of the second differential gear device D2 in the negative direction to engage the one-way clutch F1, which drivably couples the first sun gear S1 and the second sun gear S2 to each other to rotate together, and the first ring gear R1 of the first differential gear device D1 is allowed to rotate with the two-way clutch F2 in the disengaged state. In this state, first, the switching control device 35 brings the two-way clutch F2 to the one-direction engaged state. In the one-direction engaged state, the two-way clutch F2 allows rotation of the first ring gear R1 in the positive direction, and restricts rotation of the first ring gear R1 in the negative direction. In FIG. 9, the symbol “▴ (black triangle)” is used to indicate the one-direction engaged state of the two-way clutch F2.

Next, the rotational speeds and the torques of the engine E and the first rotary electric machine MG1 are controlled via the engine control unit 32 and the first rotary electric machine control unit 33 to vary the rotational speed of the first ring gear R1 of the first differential gear device D1 in the negative direction. In the embodiment, the rotational speed of the first rotary electric machine MG1 is increased by causing the first rotary electric machine MG1 to output the torque TM1 in the positive direction with the rotational speed and the torque TE of the engine E (input shaft I) kept generally constant. Consequently, the respective rotational speeds of the first rotary electric machine MG1 and the first sun gear S1, which is drivably coupled to the first rotary electric machine MG1, are varied in the positive direction, and the rotational speed of the first ring gear R1 is varied in the negative direction with the first ring gear R1 rotating in the positive direction, using the input shaft I and the first carrier CA1, which is drivably coupled to the input shaft I, as fulcrums. As the rotational speed of the first ring gear R1 is continuously reduced by increasing the rotational speed of the first rotary electric machine MG1, the rotational speed of the first ring gear R1 becomes zero in the course of time, and the first ring gear R1 is urged to rotate in the negative direction. At this time, the two-way clutch F2 is in the one-direction engaged state, and restricts rotation of the first ring gear R1 in the negative direction. Thus, the rotational speed of the first ring gear R1 is forcibly restricted to zero.

Thereafter, the switching control device 35 brings the two-way clutch F2 to the two-direction engaged state, in which rotation of the first ring gear R1 is restricted in both directions to stop rotation of the first ring gear R1. In addition, the direction of the torque TM1 of the first rotary electric machine MG1 is changed from the positive direction to the negative direction, and the first rotary electric machine MG1 is caused to output the torque TM1 with a magnitude that is required to secure a desired amount of generated electric power. Mode switching from the split mode to the series mode is thus performed. In this event, mode switching is performed only by controlling the rotational speed and the torque TM1 of the first rotary electric machine MG1 while maintaining the rotating states of the respective rotary elements of the second differential gear device D2 (the state of the velocity diagram of the second differential gear device D2) as they are. Accordingly, in the hybrid drive device H according to the embodiment, mode switching from the split mode to the series mode can be performed through relatively simple control of the first rotary electric machine MG1. It is also relatively easy to suppress variations in torque to be transferred to the output shaft O in order to suppress generation of shock at the time of mode switching.

When mode switching from the series mode to the split mode is performed, on the other hand, the two-way clutch F2 is disengaged into the disengaged state, and the one-way clutch F1 is engaged into the engaged state. In the series mode, as described above, rotation of the first ring gear R1 of the first differential gear device D1 is stopped with the two-way clutch F2 in the two-direction engaged state, and the first sun gear S1 of the first differential gear device D1 is allowed to rotate relative to the second sun gear S2 of the second differential gear device D2 in the positive direction with the one-way clutch F1 in the disengaged state. In this state, first, the switching control device 35 brings the two-way clutch F2 to the disengaged state.

Next, the rotational speeds and the torques of the engine E and the first rotary electric machine MG1 are controlled via the engine control unit 32 and the first rotary electric machine control unit 33 to vary the rotational speed of the first sun gear S1 of the first differential gear device D1 in the negative direction. In the embodiment, the rotational speed of the first rotary electric machine MG1 is reduced by maintaining as it is the torque TM1 in the negative direction, which is output from the first rotary electric machine MG1 in the series mode, with the rotational speed and the torque TE of the engine E (input shaft I) kept generally constant. As the rotational speed of the first rotary electric machine MG1 is continuously reduced, the rotational speed of the first sun gear S1 relative to the second sun gear S2 becomes zero in the course of time, and the first sun gear S1 is urged to rotate relative to the second sun gear S2 in the negative direction. As a result, the one-way clutch F1 is brought to the engaged state, which drivably couples the first rotary electric machine MG1 and the first sun gear S1 to the second sun gear S2 to rotate together with the second sun gear S2.

Thereafter, the direction of the torque TM1 of the first rotary electric machine MG1 is maintained in the negative direction, and the first rotary electric machine MG1 is caused to output the torque TM1 with a magnitude that is required to support the reaction force of the torque TE of the input shaft I (engine E). Mode switching from the series mode to the split mode is thus performed. In this event, mode switching is performed only by controlling the rotational speed and the torque TM1 of the first rotary electric machine MG1 while maintaining the rotating states of the respective rotary elements of the second differential gear device D2 (the state of the velocity diagram of the second differential gear device D2) as they are. Accordingly, in the hybrid drive device H according to the embodiment, mode switching from the series mode to the split mode can be performed through relatively simple control of the first rotary electric machine MG1. It is also relatively easy to suppress variations in torque to be transferred to the output shaft O in order to suppress generation of shock at the time of mode switching.

1-4-2. Switching Between Electric Power Travel Mode and Series Mode

FIG. 10 is a velocity diagram showing the process of switching between the electric power travel mode and the series mode. When mode switching from the electric power travel mode to the series mode is performed, the one-way clutch F1 is maintained in the disengaged state, and the two-way clutch F2 is engaged into the two-direction engaged state. In the electric power travel mode, as described above, the first ring gear R1 of the first differential gear device D1 is allowed to rotate with the two-way clutch F2 in the disengaged state, and the first sun gear S1 of the first differential gear device D1 is allowed to rotate relative to the second sun gear S2 of the second differential gear device D2 in the positive direction with the one-way clutch F1 in the disengaged state. In this state, first, the switching control device 35 brings the two-way clutch F2 to the two-direction engaged state, in which rotation of the first ring gear R1 is restricted in both directions to stop rotation of the first ring gear R1. In addition, as a result of the first rotary electric machine MG1 outputting the torque TM1 in the positive direction to vary its rotational speed in the positive direction, the rotational speed of the engine E, which is drivably coupled to the input shaft I to rotate together with the input shaft I, is increased to start up the engine E. After the engine E is started up, the direction of the torque TM1 of the first rotary electric machine MG1 is changed from the positive direction to the negative direction, and the first rotary electric machine MG1 is caused to output the torque TM1 with a magnitude that is required to secure a desired amount of generated electric power. Mode switching from the electric power travel mode to the series mode is thus performed.

When mode switching from the series mode to the electric power travel mode is performed, the one-way clutch F1 is maintained in the disengaged state, and the two-way clutch F2 is disengaged into the disengaged state. In the series mode, as described above, rotation of the first ring gear R1 of the first differential gear device D1 is stopped with the two-way clutch F2 in the two-direction engaged state, and the first sun gear S1 of the first differential gear device D1 is allowed to rotate relative to the second sun gear S2 of the second differential gear device D2 in the positive direction with the one-way clutch F1 in the disengaged state. In this state, the switching control device 35 brings the two-way clutch F2 to the disengaged state, in which rotation of the engine E and the first ring gear R1 is stopped. Mode switching from the series mode to the electric power travel mode is thus performed.

### 2. Second Embodiment

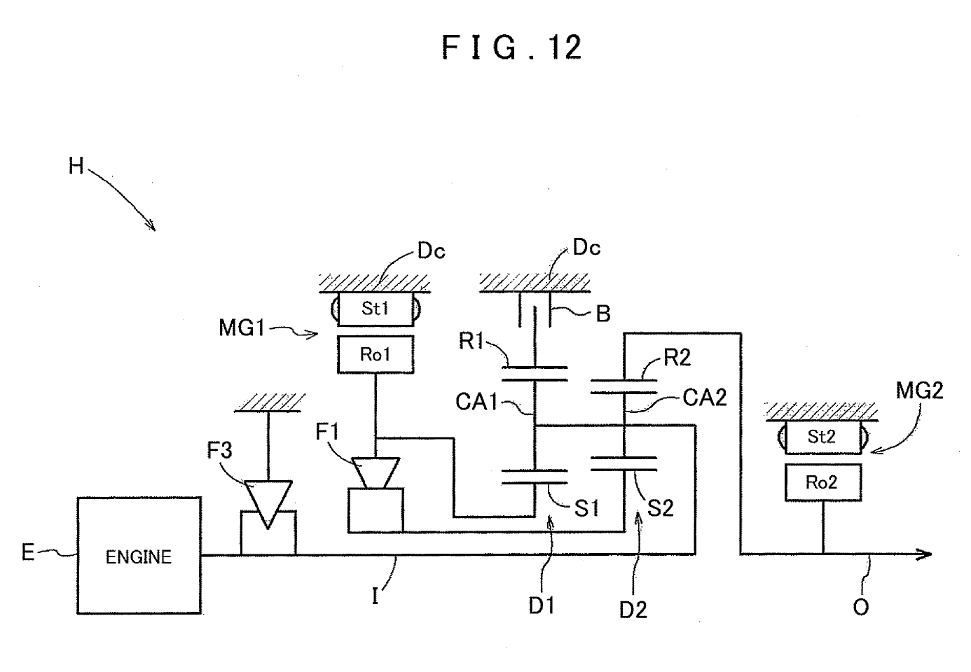

A second embodiment of the present invention will be described with reference to the drawings. FIG. 12 is a skeleton diagram showing the mechanical configuration of a hybrid drive device H according to the embodiment. In FIG. 12, as in FIG. 1, the configuration of a lower half, which is symmetrical with respect to the center axis, is not shown. The mechanical configuration of the hybrid drive device H according to the embodiment is different from the configuration of the hybrid drive device H according to the above first embodiment in that another one-way clutch (a second one-way clutch F3) is added, and in that a brake B is provided in place of the two-way clutch F2. In addition, the hybrid drive device H according to the embodiment is different from that according to the above first embodiment in being further switchably operable in a second electric power travel mode along with the addition of the second one-way clutch F3. The differences between the hybrid drive device H according to the embodiment and that according to the above first embodiment will be mainly described below. A first one-way clutch F1 according to the embodiment is equivalent to the one-way clutch F1 according to the above first embodiment, and a first electric power travel mode according to the embodiment is equivalent to the electric power travel mode according to the above first embodiment. The same elements as those in the above first embodiment will not be specifically described.

2-1. Configuration of Various Sections of Hybrid Drive Device

The brake B is provided between the case Dc serving as a non-rotary member and the first ring gear R1 of the first differential gear device D1 to selectively stop rotation of the first ring gear R1. The brake B is switchably operable in two states, namely a disengaged state and an engaged state. In the disengaged state, rotation of the first ring gear R1 relative to the case Dc is allowed in both directions (the positive direction and the negative direction). In the engaged state, rotation of the first ring gear R1 relative to the case Dc is restricted in both directions (the positive direction and the negative direction) to stop rotation of the first ring gear R1. In the embodiment, a friction engagement device (friction engagement brake) such as a multi-plate brake that operates on a hydraulic pressure is used as the brake B. In the embodiment, the brake B is equivalent to the “rotation restriction device” according to the present invention. In this case, it is suitable that a hydraulic pressure control device that controls a hydraulic pressure to be supplied to the brake B is provided. Alternatively, the brake B may operate on an electromagnetic force in place of a hydraulic pressure.

The second one-way clutch F3 is provided between the case Dc serving as a non-rotary member and the input shaft I to allow the input shaft I to rotate relative to the case Dc only in the positive direction. That is, the second one-way clutch F3 is provided to allow rotation of the input shaft I in the positive direction, and restricts rotation of the input shaft I in the negative direction. For example, in the case where the rotational speed of the input shaft I is continuously varied in the negative direction while the input shaft I is rotating in the positive direction, the second one-way clutch F3 is brought to the engaged state when the rotational speed of the input shaft I becomes zero so that the input shaft I is secured to the case Dc. In the embodiment, the second one-way clutch F3 is equivalent to the “second rotational direction restriction device” according to the present invention. In the embodiment, the second one-way clutch F3 is disposed between the engine E and the first rotary electric machine MG1 in the axial direction.

2-2. Plurality of Switchable Modes

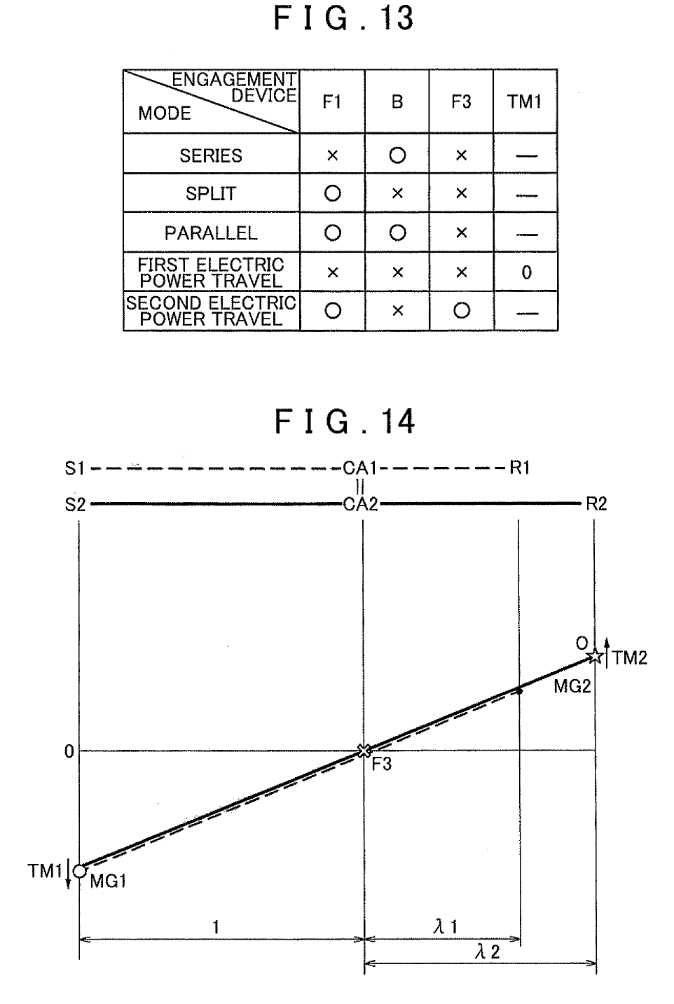

FIG. 13 is an operation table showing the operating states of the respective engagement devices F1, F3, and B and the direction of the torque TM1 of the first rotary electric machine MG1 in each mode. In FIG. 13, the symbol “∘” indicates that each engagement device is in the engaged state, and the symbol “x” indicates that each engagement device is in the disengaged state. In FIG. 3, in addition, the symbol “-” indicates that the torque TM1 of the first rotary electric machine MG1 is in the negative direction, and the symbol “0” indicates that the first rotary electric machine MG1 is basically outputting no torque TM1, and making no rotation or idling. In the embodiment, as shown in FIG. 13, the hybrid drive device H is switchably operable in five modes, namely the “series mode”, the “split mode”, the “parallel mode”, the “first electric power travel mode”, and the “second electric power travel mode”.

In the series mode, the split mode, the parallel mode, and the first electric power travel mode according to the embodiment, the second one-way clutch F3 is in the disengaged state. Thus, these modes are considered to be the same as the respective corresponding modes according to the above first embodiment. In each of these modes, the “two-direction engaged state of the two-way clutch F2” in the above first embodiment is replaced with the “engaged state of the brake B”.

In the second electric power travel mode, the torque TM1 of the first rotary electric machine MG1 and the torque TM2 of the second rotary electric machine MG2 are transferred to the output shaft O. In the embodiment, in the second electric power travel mode, the torque TM1 and the rotational direction of the first rotary electric machine MG1 are reversed and transferred to the output shaft O, and the torque TM2 of the second rotary electric machine MG2 is transferred as it is to the output shaft O. As shown in FIG. 13, the second electric power travel mode is established with both the first one-way clutch F1 and the second one-way clutch F3 in the engaged state and with the brake B in the disengaged state. That is, the second electric power travel mode is established with the first ring gear R1 of the first differential gear device D1 allowed to rotate with the brake B in the disengaged state, with the first sun gear S1 of the first differential gear device D1 urged to rotate relative to the second sun gear S2 of the second differential gear device D2 in the negative direction to engage the first one-way clutch F1, which drivably couples the first sun gear S1 to the second sun gear S2 to rotate together with the second sun gear S2, and with the input shaft I urged to rotate in the negative direction to engage the second one-way clutch F3, which secures the input shaft to the case Dc.

When the vehicle is traveling forward in the second electric power travel mode, as shown in the velocity diagram of FIG. 14, the line representing the first differential gear device D1 and the line representing the second differential gear device D2 are identical lines. In the second differential gear device D2, the first carrier CA1 of the first differential gear device D1 is drivably coupled to the second carrier CA2, which is at the middle in the order of rotational speed, and the output shaft O and the rotor Ro2 of the second rotary electric machine MG2 are drivably coupled to the second ring gear R2, which is on one side in the order of rotational speed. In the first differential gear device D1, the second carrier CA2 of the second differential gear device D2 is drivably coupled to the first carrier CA1, which is at the middle in the order of rotational speed, and the rotor Ro1 of the first rotary electric machine MG1 is drivably coupled to the first sun gear S1, which is on one side in the order of rotational speed. In this state, the first rotary electric machine MG1 outputs the torque TM1 in the negative direction as also shown in FIG. 13. As a result of the first rotary electric machine MG1 outputting the torque TM1 in the negative direction, the rotational speed of the first sun gear S1 is reduced, and the first sun gear S1 is urged to rotate relative to the second sun gear S2 in the negative direction. When the rotational speed of the first sun gear S1 relative to the second sun gear S2 becomes zero, the first one-way clutch F1 is brought to the engaged state, which drivably couples the first rotary electric machine MG1 and the first sun gear S1 to the second sun gear S2 to rotate together with the second sun gear S2.

In addition, as a result of the first rotary electric machine MG1 further continuously outputting the torque TM1 in the negative direction, the respective rotational speeds of the first sun gear S1 and the second sun gear S2, which rotate together with the first rotary electric machine MG1, are varied in the negative direction. In synchronization with such variations, the rotational speed of the input shaft I, which rotates together with the first carrier CA1 and the second carrier CA2, is also varied in the negative direction, the rotational speed of the input shaft I becomes zero in the course of time, and the input shaft I is urged to rotate in the negative direction. At this time, in the embodiment, the input shaft I and the first carrier CA 1 and the second carrier CA2, which rotate together, are secured to the case Dc through the second one-way clutch F3. Thus, the rotational speeds of the input shaft I and the first carrier CA1 and the second carrier CA2 are forcibly restricted to zero.

In the second electric power travel mode, the second carrier CA2 of the second differential gear device D2, which is at the middle in the order of rotational speed, is secured to the case Dc through the second one-way clutch F3, and the torque TM1 of the first rotary electric machine MG1 is input to the second sun gear S2, which is on one side in the order of rotational speed, via the first sun gear S1 and the first one-way clutch F1. In addition, the output shaft O is drivably coupled to the second ring gear R2, which is on the other side in the order of rotational speed. In this state, the first rotary electric machine MG1 performs power running by outputting the torque TM1 in the negative direction while rotating in the negative direction. Then, the torque TM1 of the first rotary electric machine MG1 in the negative direction is reversed by the second differential gear device D2 and transferred to the output shaft O, which drives the vehicle. In this event, the rotational speed of the first rotary electric machine MG1 is reduced and the torque TM1 is amplified, before being transferred to the output shaft O. Meanwhile, the second rotary electric machine MG2 outputs the torque TM2 in the positive direction to supplement the torque to be transferred to the output shaft O.

In the second electric power travel mode, the vehicle can also travel in reverse. In this case, it is not always necessary that the first one-way clutch F1 should be in the engaged state, which drivably couples the first rotary electric machine MG1 and the first sun gear S1 to the second sun gear S2 to rotate together with the second sun gear S2, and that the input shaft I (the first carrier CA1 and the second carrier CA2) should be secured to the case Dc through the second one-way clutch F3. That is, in the case where the first rotary electric machine MG1 is caused to output the torque TM1 in the positive direction while rotating in the positive direction to perform power running in order to travel in reverse, the first sun gear S1 may rotate relative to the second sun gear S2 in the positive direction to bring the first one-way clutch F1 to the disengaged state, or the input shaft I may rotate in the positive direction to bring the second one-way clutch F3 to the disengaged state.

2-3. Switching Between Modes

In the hybrid drive device H according to the embodiment, switching between the series mode and the split mode is basically performed in the same way as in the above first embodiment. In the embodiment, however, the rotational speed of the first ring gear R1 is not forcibly restricted to zero in mode switching from the split mode to the series mode since the brake B is used as the rotation restriction device, unlike the above first embodiment in which the two-way clutch F2 which can take the one-direction engaged state is provided as the rotation restriction device. Thus, in the embodiment, in mode switching from the split mode to the series mode, the rotational speed of the first rotary electric machine MG1 is controlled such that the rotational speed of the first ring gear R1 converges to zero, and subsequently the first ring gear R1 is secured to the case Dc through the brake B. In the hybrid drive device H according to the embodiment, while it is preferable to perform such synchronous control, mode switching from the split mode to the series mode can be performed through relatively simple control of the first rotary electric machine MG1. It is also relatively easy to suppress variations in torque to be transferred to the output shaft O in order to suppress generation of shock at the time of mode switching. Accordingly, the hybrid drive device H with simple mode switching control can also be achieved in the embodiment.

### Other Embodiments

(1) In the above first embodiment, the hybrid drive device H is switchably operable in four modes, namely the “series mode”, the “split mode”, the “parallel mode”, and the “electric power travel mode (first electric power travel mode)”. In the above second embodiment, meanwhile, the hybrid drive device H is switchably operable in five modes, namely the “second electric power travel mode” in addition to the above four modes. However, the present invention is not limited thereto. That is, it is suitable that the hybrid drive device H is switchably operable in at least the split mode and the series mode. In one suitable embodiment of the present invention, the hybrid drive device H is switchably operable in one or more of the above four (or five) modes and/or one or more modes other than the above four (or five) modes in addition to the split mode and the series mode.

(2) In the above first embodiment, the two-way clutch F2 is switchably operable in three states, namely the disengaged state, the one-direction engaged state, and the two-direction engaged state. However, the present invention is not limited thereto. That is, in one suitable embodiment of the present invention, the two-way clutch F2 is switchably operable in three states, namely the disengaged state, a first one-direction engaged state, and a second one-direction engaged state. The directions in which rotation of the first ring gear R1 is allowed and restricted in the first one-direction engaged state are respectively opposite to the corresponding directions in the second one-direction engaged state. For example, in the first one-direction engaged state, the two-way clutch F2 allows rotation of the first ring gear R1 in the positive direction, and restricts rotation of the first ring gear R1 in the negative direction. In the second one-direction engaged state, meanwhile, the two-way clutch F2 restricts rotation of the first ring gear R1 in the positive direction, and allows rotation of the first ring gear R1 in the negative direction. Then, the two-way clutch F2 may be brought to the first one-direction engaged state in the split mode, the parallel mode, and the engine start-up mode (which is part of the series mode), in which rotation of the first ring gear R1 in the negative direction should be restricted. Meanwhile, the two-way clutch F2 may be brought to the second one-direction engaged state in the normal series mode, in which rotation of the first ring gear R1 in the positive direction should be restricted.

(3) In the above first embodiment, the two-way clutch F2 is provided as the rotation restriction device. In the above second embodiment, the brake B is provided as the rotation restriction device. However, the present invention is not limited thereto. That is, the two-way clutch F2 and the brake B may be exchanged in the above embodiments. In one suitable embodiment of the present invention, the brake B is provided as the rotation restriction device in the configuration of the above first embodiment, or the two-way clutch F2 is provided as the rotation restriction device in the configuration of the above second embodiment.

(4) In the above first embodiment, an example of the specific configuration of the two-way clutch F2 is described with reference to the drawing. However, the present invention is not limited thereto. That is, the specific configuration of the two-way clutch F2 may be appropriately changed. In one suitable embodiment of the present invention, the hybrid drive device H is formed using a two-way clutch with a different configuration.

(5) In the above second embodiment, in mode switching from the split mode to the series mode, the rotational speed of the first rotary electric machine MG1 is controlled such that the rotational speed of the first ring gear R1 converges to zero, and subsequently the first ring gear R1 is secured to the case Dc through the brake B. However, the present invention is not limited thereto. That is, in one suitable embodiment of the present invention, mode switching from the split mode to the series mode is performed by controlling the magnitude of the hydraulic pressure to be supplied to the brake B so as to gradually increase the engagement force of the brake B, which converges the rotational speed of the first ring gear R1 to secure the first ring gear R1.

(6) In each of the above embodiments, the tooth number ratio λ2 of the second differential gear device D2 is set to be larger than the tooth number ratio λ1 of the first differential gear device D1 (λ2=λ1). However, the present invention is not limited thereto. That is, in one suitable embodiment of the present invention, the tooth number ratio λ2 of the second differential gear device D2 is set to be smaller than the tooth number ratio λ1 of the first differential gear device D1 (λ2<λ1). In this case, the vehicle can travel forward in the parallel mode, for example.

In another suitable embodiment of the present invention, the tooth number ratio λ2 of the second differential gear device D2 is set to be equal to the tooth number ratio λ1 of the first differential gear device D1 (λ2=λ1). In this case, the engine E can be started up with the vehicle maintained in the stationary state in the series mode (engine start-up mode).

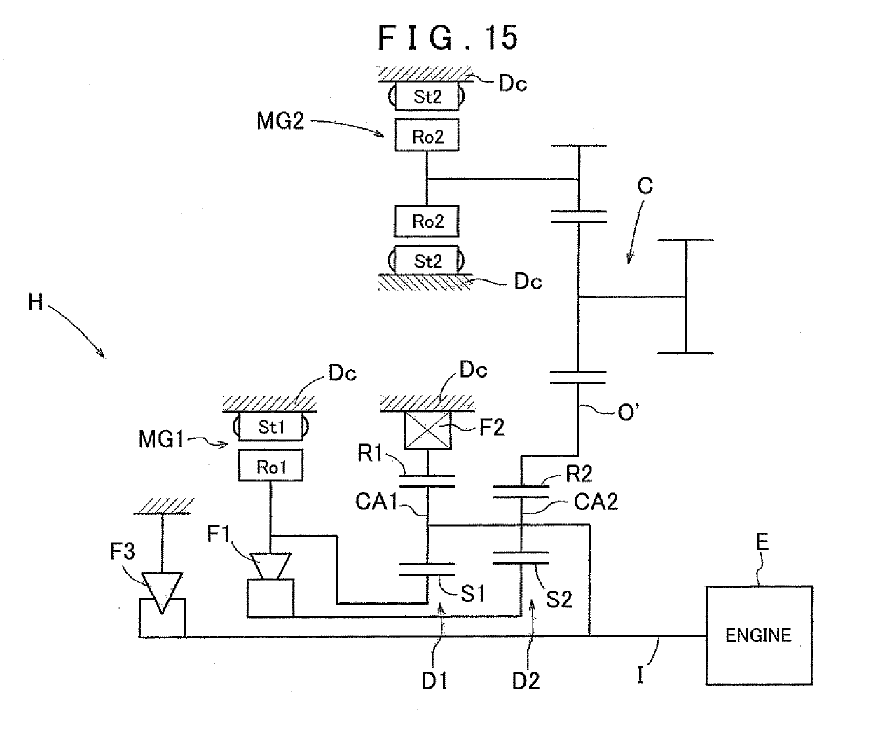

(7) In each of the above embodiments, both the first rotary electric machine MG1 and the second rotary electric machine MG2 are disposed coaxially with the input shaft I. However, the present invention is not limited thereto. That is, in one suitable embodiment of the present invention, only the first rotary electric machine MG1 is disposed coaxially with the input shaft, and the second rotary electric machine MG2 and the first rotary electric machine MG1 are disposed on different axes from each other. An exemplary configuration of such a hybrid drive device H is shown in FIG. 15. In the illustrated example, an output gear O′ serving as an output member is integrally drivably coupled to the second ring gear R2 of the second differential gear device D2. The output gear O′ is drivably coupled to a counter gear mechanism C. The second rotary electric machine MG2 is also drivably coupled to the counter gear mechanism C. Consequently, the second rotary electric machine MG2 is drivably coupled to the output gear O′ via the counter gear mechanism C. In the hybrid drive device H, both a torque transferred to the output gear O′ and the torque TM2 of the second rotary electric machine MG2 are transferred to the wheels W side via the counter gear mechanism C and the output differential gear device DF. In the embodiment, the second one-way clutch F3 is disposed opposite the engine E across the first rotary electric machine MG1 and the two differential gear devices D1 and D2 in the axial direction. Such a configuration is suitable as a configuration of the hybrid drive device H to be mounted on FF (front-engine front-drive) vehicles, for example.

The present invention is suitably applicable to a hybrid drive device including an input member drivably coupled to an engine, a first rotary electric machine, a second rotary electric machine, an output member drivably coupled to a wheel and the second rotary electric machine, and a first differential gear device having three rotary elements that form a sequence of a first rotary element, a second rotary element, and a third rotary element when arranged in the order of rotational speed.

What is claimed is:

1. A hybrid drive device comprising:
an input member drivably coupled to an engine;
a first rotary electric machine;
a second rotary electric machine;
an output member drivably coupled to a wheel and the second rotary electric machine;
a first differential gear device and a second differential gear device each having three rotary elements that form a sequence of a first rotary element, a second rotary element, and a third rotary element when arranged in the order of rotational speed;
a rotation restriction device that performs restriction such that rotation of the third rotary element of the first differential gear device is selectively stopped; and
a first rotational direction restriction device that performs restriction such that rotation of the first rotary element of the first differential gear device relative to the first rotary element of the second differential gear device is allowed only in a positive direction, wherein
the input member is drivably coupled to the second rotary element of the first differential gear device and the second rotary element of the second differential gear device,
the output member is drivably coupled to the third rotary element of the second differential gear device, and
the first rotary electric machine is drivably coupled to the first rotary element of the first differential gear device.

2. The hybrid drive device according to claim 1, wherein the hybrid drive device is switchably operable in a series mode which is established with the rotation restriction device stopping rotation of the third rotary element of the first differential gear device and with the first rotary element of the first differential gear device allowed to rotate relative to the first rotary element of the second differential gear device in the positive direction, and in which a torque of the input member is used by the first rotary electric machine to generate electric power, which is consumed by the second rotary electric machine to output a torque, which is transferred to the output shaft, and a split mode which is established with the first rotational direction restriction device drivably coupling the first rotary element of the first differential gear device to the first rotary element of the second differential gear device to rotate together with the first rotary element of the second differential gear device and with the rotation restriction device allowing rotation of the third rotary element of the first differential gear device, and in which the torque of the input member is transferred to the output member while being distributed to the first rotary electric machine.

3. The hybrid drive device according to claim 2, wherein the hybrid drive device is further switchably operable in a parallel mode which is established with the rotation restriction device stopping rotation of the third rotary element of the first differential gear device and with the first rotational direction restriction device drivably coupling the first rotary element of the first differential gear device to the first rotary element of the second differential gear device to rotate together with the first rotary element of the second differential gear device, and in which rotation of the input member is reduced in speed and transferred to the output member and the torque of the second rotary electric machine is transferred to the output member.

4. The hybrid drive device according to claim 2, wherein the hybrid drive device is further switchably operable in a first electric power travel mode which is established with the rotation restriction device allowing rotation of the third rotary element of the first differential gear device and with the first rotary element of the first differential gear device allowed to rotate relative to the first rotary element of the second differential gear device in the positive direction, and in which the torque of the second rotary electric machine is transferred to the output member.

5. The hybrid drive device according to claim 2, further comprising a second rotational direction restriction device provided between a non-rotary member and the input member to perform restriction such that rotation of the input member relative to the non-rotary member is allowed only in the positive direction, wherein the hybrid drive device is further switchably operable in a second electric power travel mode which is established with the rotation restriction device allowing rotation of the third rotary element of the first differential gear device, with the first rotational direction restriction device drivably coupling the first rotary element of the first differential gear device to the first rotary element of the second differential gear device to rotate together with the first rotary element of the second differential gear device, and with the second rotational direction restriction device securing the input member to the non-rotary member, and in which a torque and a rotational direction of the first rotary electric machine are reversed and transferred to the output member and the torque of the second rotary electric machine is transferred to the output member.

6. The hybrid drive device according to claim 2, wherein the rotation restriction device is provided between a non-rotary member and the third rotary element of the first differential gear device, and is switchably operable in at least two states including a state in which restriction is performed such that rotation of the third rotary element of the first differential gear device relative to the non-rotary member is allowed only in the positive direction, and a state in which rotation of the third rotary element of the first differential gear device relative to the non-rotary member is restricted in both directions to stop rotation of the third rotary element of the first differential gear device, and mode switching from the split mode to the series mode is performed by bringing, in the split mode, the rotation restriction device to the state in which rotation of the third rotary element of the first differential gear device is allowed only in the positive direction, varying a rotational speed of the third rotary element of the first differential gear device in a negative direction, restricting the rotational speed of the third rotary element of the first differential gear device to zero through the rotation restriction device, and thereafter bringing the rotation restriction device to the state in which rotation of the third rotary element of the first differential gear device is restricted in both directions to stop rotation of the third rotary element of the first differential gear device.

7. The hybrid drive device according to claim 1, wherein the rotation restriction device is a two-way clutch that is provided between a non-rotary member and the third rotary element of the first differential gear device and that is switchably operable in at least three states including a state in which rotation of the third rotary element of the first differential gear device relative to the non-rotary member is allowed in both directions, a state in which restriction is performed such that rotation of the third rotary element of the first differential gear device relative to the non-rotary member is allowed only in the positive direction, and a state in which rotation of the third rotary element of the first differential gear device relative to the non-rotary member is restricted in both directions to stop rotation of the third rotary element of the first differential gear device.

8. The hybrid drive device according to claim 1, wherein the rotation restriction device is a friction engagement brake that is provided between a non-rotary member and the third rotary element of the first differential gear device and that is switchably operable in at least two states including a state in which rotation of the third rotary element of the first differential gear device relative to the non-rotary member is allowed in both directions, and a state in which rotation of the third rotary element of the first differential gear device relative to the non-rotary member is restricted in both directions to stop rotation of the third rotary element of the first differential gear device.

9. The hybrid drive device according to claim 1, further comprising a second rotational direction restriction device provided between a non-rotary member and the input member to perform restriction such that rotation of the input member relative to the non-rotary member is allowed only in the positive direction.

10. The hybrid drive device according to claim 1, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

11. The hybrid drive device according to claim 4, wherein the hybrid drive device is further switchably operable in a first electric power travel mode which is established with the rotation restriction device allowing rotation of the third rotary element of the first differential gear device and with the first rotary element of the first differential gear device allowed to rotate relative to the first rotary element of the second differential gear device in the positive direction, and in which the torque of the second rotary electric machine is transferred to the output member.

12. The hybrid drive device according to claim 11, further comprising a second rotational direction restriction device provided between a non-rotary member and the input member to perform restriction such that rotation of the input member relative to the non-rotary member is allowed only in the positive direction, wherein the hybrid drive device is further switchably operable in a second electric power travel mode which is established with the rotation restriction device allowing rotation of the third rotary element of the first differential gear device, with the first rotational direction restriction device drivably coupling the first rotary element of the first differential gear device to the first rotary element of the second differential gear device to rotate together with the first rotary element of the second differential gear device, and with the second rotational direction restriction device securing the input member to the non-rotary member, and in which a torque and a rotational direction of the first rotary electric machine are reversed and transferred to the output member and the torque of the second rotary electric machine is transferred to the output member.

13. The hybrid drive device according to claim 12, wherein the rotation restriction device is provided between a non-rotary member and the third rotary element of the first differential gear device, and is switchably operable in at least two states including a state in which restriction is performed such that rotation of the third rotary element of the first differential gear device relative to the non-rotary member is allowed only in the positive direction, and a state in which rotation of the third rotary element of the first differential gear device relative to the non-rotary member is restricted in both directions to stop rotation of the third rotary element of the first differential gear device, and mode switching from the split mode to the series mode is performed by bringing, in the split mode, the rotation restriction device to the state in which rotation of the third rotary element of the first differential gear device is allowed only in the positive direction, varying a rotational speed of the third rotary element of the first differential gear device in a negative direction, restricting the rotational speed of the third rotary element of the first differential gear device to zero through the rotation restriction device, and thereafter bringing the rotation restriction device to the state in which rotation of the third rotary element of the first differential gear device is restricted in both directions to stop rotation of the third rotary element of the first differential gear device.

14. The hybrid drive device according to claim 13, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

15. The hybrid drive device according to claim 2, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

16. The hybrid drive device according to claim 7, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

17. The hybrid drive device according to claim 8, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

18. The hybrid drive device according to claim 9, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

19. The hybrid drive device according to claim 3, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.

20. The hybrid drive device according to claim 4, wherein the first differential gear device and the second differential gear device are each formed by a planetary gear mechanism including a sun gear serving as the first rotary element, a carrier serving as the second rotary element, and a ring gear serving as the third rotary element, and when a ratio of the number of teeth of the sun gear to the number of teeth of the ring gear is defined as a tooth number ratio, a tooth number ratio of the second differential gear device is set to be larger than a tooth number ratio of the first differential gear device.
